(19) United States
(12) Patent Application Publication
(10) Pub. No.: US 2026/0074202 A1
(43) Pub. Date: Mar. 12, 2026

(54) MOLTEN SALT SODIUM OXYGEN BATTERY

(71) Applicant: MASSACHUSETTS INSTITUTE OF TECHNOLOGY, Cambridge, MA (US)

(72) Inventors: Yang Shao-Horn, Newton, MA (US); Graham Leverick, Somerville, MA (US); Yun Guang Zhu, San Diego, CA (US)

(21) Appl. No.: 18/872,057

(22) PCT Filed: Jun. 9, 2023
(86) PCT No.: PCT/US2023/068171

§ 371 Date: Dec. 5, 2024

Related U.S. Application Data
(60) Provisional application No. 63/351,337, filed on Jun. 10, 2022.

(51) Int. Cl. H01M 4/36; H01M 4/38; H01M 4/58; H01M 10/054; H01M 10/0562; H01M 10/058

(52) U.S. Cl. CPC H01M 4/368; H01M 4/364; H01M 4/38; H01M 4/381; H01M 4/5825; H01M 10/054; H01M 10/0562; H01M 10/058; H01M 2300/0071

(57) ABSTRACT

Described herein is a molten-salt Na—O₂ battery which includes a first electrode including liquid Na in direct contact with a solid-state electrolyte; and a composite second electrode in contact with the solid-state electrolyte, wherein the composite second electrode includes: particles having an oxygen-active metal surface; and a molten salt comprising redox-active ions; and O₂ in contact with the composite second electrode; where the solid-state electrolyte is disposed between the first electrode and the composite second electrode. Methods of making the battery and methods of producing electricity with the battery are also described.

### CLAIM OF PRIORITY

This application claims priority to U.S. Application No. 63/351,337, filed on Jun. 10, 2022, the contents of which are hereby incorporated by reference in their entirety.

### STATEMENT REGARDING FEDERALLY SPONSORED RESEARCH OR DEVELOPMENT

This invention was made with government support under N00014-20-1-2221 awarded by the U.S. Navy, Office of Naval Research (ONR). The government has certain rights in the invention.

### BACKGROUND

Alkali metal-oxygen batteries have high theoretical energy densities and are promising electrochemical energy storage systems to enable the electrification of heavy-duty vehicles and aviation. For instance, Li—, Na—, and K—O₂ batteries can deliver values of specific energy of 3458 Wh/kg (Li, Oz/active Li₂O₂), 1103 Wh/kg (Na, O₂/active NaO₂), and 935 Wh/kg (K, O₂/active KO₂) at room temperature, respectively. However, the formation of dendrites and the high reactivity of alkali metals has hindered the development of metal-based batteries, including metal-oxygen batteries. Research effort has focused on modifying the alkali metal negative electrode to increase rechargeability and stability, especially that of lithium metal. Moreover, the kinetics of the oxygen reduction and evolution reactions (ORR and OER) and diffusion of oxygen in the air electrode can increase the overpotentials at the positive electrode of metal-oxygen batteries, leading to poor energy efficiencies. To address the overpotentials of metal-oxygen batteries, solid electrochemical catalysts and redox mediators have been intensely investigated. Yet the (electro) chemical stability of the electrodes and electrolyte against reaction intermediates and products, as well as the operating voltages, remain challenges in this field.

### SUMMARY

In one aspect, a molten-salt Na—O₂ battery includes a first electrode including liquid Na in direct contact with a solid-state electrolyte, and a composite second electrode in contact with the solid-state electrolyte, where the composite second electrode includes particles having an oxygen-active metal surface and a molten salt including redox-active ions, and oxygen in contact with the composite second electrode, and where the solid-state electrolyte is disposed between the first electrode and the composite second electrode.

In some embodiments, the redox-active ions can be nitrate (NO₃⁻) ions. The molten salt can include a eutectic alkali metal-nitrate mixture. The eutectic alkali metal-nitrate mixture can include NaNO₃, KNO₃, and CsNO₃. The particles having an oxygen-active metal surface can include Ni, Cu, or a combination thereof. The particles having an oxygen-active metal surface can include at least some metal oxide. The particles having an oxygen-active metal surface can be Ni particles and can include at least some NiO, Ni₂O₃, or a combination thereof. The solid-state electrolyte can be a β-Al₂O₃ membrane.

In some embodiments, the battery can be characterized by an areal energy density of at least about 30 mWh/cm²_{geo}. The battery can be characterized by an areal power density of at least about 15 mW/cm²_{geo}. The battery can be characterized by stable cycling through at least about 400 charge-discharge cycles. The battery can be characterized by an energy efficiency of at least about 85%.

In another aspect, a method of making a molten-salt Na—O₂ battery includes providing a battery housing, loading the battery housing with an amount of Na, assembling a solid-state electrolyte within the battery housing such that the solid-state electrolyte directly contacts the Na, forming a composite second electrode, wherein forming includes combining metal particles and a redox-active salt in predetermined ratios, thereby yielding a solid mixture, and compressing the solid mixture on a conductive substrate and assembling the composite second electrode within the battery housing such that the solid-state electrolyte is disposed between the Na and the composite second electrode.

In some embodiments, the method can further include loading the battery housing with an amount of O₂, where the O₂ is in contact with composite second electrode and separated from the Na. The method can further include exposing the assembled battery to a predetermined operating temperature, wherein at predetermined operating temperature, the Na is liquid and the redox-active salt is a molten salt.

In some embodiments, the redox-active salt can be a eutectic alkali metal-nitrate mixture comprising NaNO₃, KNO₃, and CsNO₃. The metal particles can be Ni nanoparticles.

In another aspect, a method of producing electricity includes providing a molten-salt Na—O₂ battery which includes a first electrode comprising liquid Na in direct contact with a solid-state electrolyte, a composite second electrode in contact with the solid-state electrolyte, where the composite second electrode includes particles having an oxygen-active metal surface and a molten salt including redox-active ions, where the solid-state electrolyte is disposed between the first electrode and the composite second electrode, allowing O₂ to contact the composite second electrode; exposing the battery to a predetermined operating temperature selected to maintain Na in a liquid state and to maintain the molten salt in a molten state; and providing an electrical connection between the first electrode and the second composite electrode.

In some embodiments, the redox-active salt can be a eutectic alkali metal-nitrate mixture comprising NaNO₃, KNO₃, and CsNO₃. The particles having an oxygen-active metal surface can be Ni nanoparticles.

In another aspect, a battery can include molten salt Na—O₂, a dendrite-free liquid-Na electrode, stable nickel positive electrode, and fast kinetics of oxygen reduction and oxidation.

In one embodiment, the battery disclosed herein further comprises a NaNO₃/KNO₃/CsNO₃ eutectic electrolyte and a β-Al₂O₃ membrane.

In one embodiment of the battery disclosed herein, the battery has a power density of 19 mW/cm²_{geo}.

In one embodiment of the battery disclosed herein, the battery has an energy efficiency of >90%.

In one embodiment of the battery disclosed herein, the battery has a current of 10 mA/cm²_{geo}.

In one embodiment of the battery disclosed herein, the battery has a cycling stability of 400 cycles with 100% retention.

Additional embodiments are described in the detailed description, the examples, and the claims.

### BRIEF DESCRIPTION OF THE DRAWINGS

FIG. 1A is schematic diagram of a molten-salt Li—O₂ battery. FIG. 1B is a schematic diagram of a molten-salt Na—O₂ battery. The molten-salt Na—O₂ battery has a liquid Na metal negative electrode, solid-state electrolyte, and metal oxide-based oxygen positive electrode with eutectic salts (for example, NaNO₃ (26.4 w %)/KNO₃ (27.3 w %)/CsNO₃ (46.3 w %). FIG. 1C is a comparison of energy and power densities based on the area of the positive electrode in a Ragone plot for alkali metal-oxygen batteries (Li—O₂, Na—O₂, and K—O₂ batteries (Refs. 17-18 and 35-43).

FIG. 1D is a schematic of a battery.

FIGS. 2A-2D show the electrochemical performance of molten-salt Na—O₂ batteries. FIG. 2A shows discharge profiles of molten-salt Na—O₂ batteries at different current densities (0.2, 1.0, 2.0, and 10.0 mA/cm²_{geo}). The inset of FIG. 2A is a schematic diagram of a molten-salt Na—O₂ battery, including liquid Na negative electrode, β-Al₂O₃ membrane, Ni/NaNO₃/KNO₃/CsNO₃/SS positive electrode, stainless steel (SS) mesh current collector, and O₂. FIG. 2B shows charge-discharge profiles of molten-salt Na—O₂ batteries at different current densities (1, 2, 5, 10 mA/cm² geo) with a limited discharge capacity of 1.0 mAh/cm²_{geo} (˜6% depth of discharge based on 16 mAh/cm²_{geo} in (FIG. 2A)). FIG. 2C shows charge-discharge profiles of a molten-salt Na—O₂ battery at a current density of 5 mA/cm²_{geo} (1^{st}, 50^{th}, 100^{th}, 200^{th}, 300^{th}, and 400^{th} cycles) with a limited discharge capacity of 0.5 mAh/cm²_{geo} (˜3% depth of discharge based on 16 mAh/cm²_{geo} in (FIG. 2A)). Cycling at deeper depths of discharge was limited by the β-Al₂O₃ membrane. FIG. 2D shows the Coulombic (CE) and energy efficiencies (EE) of a molten-salt Na—O₂ battery at a current density of 5 mA/cm²_{geo} for 400 cycles. All of the above cells were tested at 443 K on a hot plate with thermal insulation, where fluctuations during cycling are attributed to changes in the cell temperature. The molten salt was a mixture of NaNO₃ (26.4 w %), KNO₃ (27.3 w %), and CsNO₃ (46.3 w %).

FIG. 3 shows the discharge profiles of molten-salt Na—O₂ batteries with Ni/salts electrodes with the different ratios of Ni/salts (2/1, 8/5, and 4/3). The discharge current was 0.2 mA/cm²_{geo}. The operation temperature was 443 K. The O₂ pressure in the cell was ˜280 kPa at room temperature. The salts were the mixture of NaNO₃ (26.4 w %), KNO₃ (27.3 w %), and CsNO₃ (46.3 w %).

FIG. 4 shows the change of the areal capacities and plateau voltages with increasing discharge currents (0.2, 1.0, 2.0, 10.0 mA/cm²_{geo}).

FIG. 5A shows electrochemical impedance spectroscopy (EIS) measurements of a molten-salt Na—O₂ battery, including the contact resistance and the resistance from β-Al₂O₃ and the interface between β-Al₂O₃ and liquid Na or Ni/NaNO₃/KNO₃/CsNO₃/SS oxygen electrode. FIG. 5B shows fitting details from the electrochemical impedance spectroscopy (EIS) spectra in (a). R1: ohmic resistance, R2: charge transfer resistance, R3: ionic resistance of β-Al₂O₃ membrane, W3: Warburg constant, Li⁺ diffusion in β-Al₂O₃ membrane.

FIGS. 6A-6C show voltage profiles of a molten-salt Na—O₂ cell using the galvanostatic intermittent titration technique (GITT) measurement. FIG. 6A shows the voltage profiles with time in galvanostatic intermittent titration technique (GITT) measurements. The two selected steps from discharge (FIG. 6B) and charge (FIG. 6C) in the GITT process. The scenario of GITT in the discharge was 30 min of discharge at a current density of 0.2 mA/cm²_{geo} and then 30 min of rest. The scenario of GITT in the charge at a current density of 0.2 mA/cm²_{geo} was 30 min of charge and then 30 min of rest. The molten-salt Na—O₂ cell were tested at 443 K. The salts were a mixture of NaNO₃ (26.4 w %), KNO₃ (27.3 w %), and CsNO₃ (46.3 w %).

FIG. 7A shows charge-discharge profiles of a molten-salt Na—O₂ battery at a current density of 5 mA/cm²_{geo} (1^{st}, 10^{th}, 20^{th}, 50^{th}, and 100^{th} cycles) with a limited discharge capacity of 1.0 mAh/cm²_{geo}. FIG. 7B shows the Coulombic (CE) and energy efficiencies (EE) of a molten-salt Na—O₂ battery at a current density of 5 mA/cm²_{geo} for 100 cycles. The Na—O₂ cell were tested at 443 K. The salts were a mixture of NaNO₃ (26.4 w %), KNO; (27.3 w %), and CsNO₃ (46.3 w %).

FIG. 8 shows a comparison of capacity-voltage plot for alkali metal-oxygen batteries (Li—O₂, Na—O₂, and K—O₂ batteries (Refs. 1-11)).

FIGS. 9A-9E show characterization of Ni/NaNO₃/KNO₃/CsNO₃/SS electrodes before and after discharge in molten-salt Na—O₂ batteries. FIG. 9A shows the Raman spectra of Ni/NaNO₃/KNO₃/CsNO₃/SS electrodes before and after discharge. Raman spectra of commercial Na₂O₂, NaNO₃, KNO₃, CsNO₃ and eutectic salts (Na/K/CsNO₃) were used as the references.

FIG. 9B shows the XRD patterns of Ni/NaNO₃/KNO₃/CsNO₃/SS electrodes before and after discharge and that of commercial Na₂O₂ powder. Several standard XRD patterns of NaNO₃ are references. B—KNO₃ was formed in the quenching process (Ref. 46) and its XRD is from Materials project (Ref. 47). The discharged electrode was washed using dimethyl sulfoxide (DMSO) and then acetonitrile (AN) for the characterization of Raman spectra and XRD. FIGS. 9C-9D show the morphology of pristine (FIG. 9C) and discharged (FIG. 9D) electrodes at current of 1 mA/cm²_{geo} for ˜10 mAh/cm²_{geo} (FIG. 2A). The scale bars in SEM images are 10 μm. FIG. 9E shows O₂ pressure tracking during discharge of a molten-salt Na—O₂ battery. The black lines represent the oxygen consumption with 1, 2, and 4 electrons per oxygen (e/O₂) processes. The effective geometric area of the Ni/NaNO₃/KNO₃/CsNO₃/SS electrode in this measurement is 0.5 cm².

FIG. 10 shows a cyclic voltammogram of a molten salt Na—O₂ cell in O₂ atmosphere ranging from 1.8 to 2.8 V. The scanning rate was set as 0.2 mV/s. The molten-salt Na—O₂ cell contains liquid Na negative electrode, β-Al₂O₃ membrane, Ni/salts positive electrode, 280 kPa O₂ (RT), Stainless steel (SS) plate. The salts are a mixture of NaNO₃ (26.4 w %), KNO₃ (27.3 w %), and CsNO₃ (46.3 w %).

FIGS. 11A-11D illustrate electrochemical performance and characterization of molten-salt Na—Ar batteries. FIG. 11A shows titration results of pristine and discharged Ni/NaNO₃/KNO₃/CsNO₃/SS electrodes in O₂ and Ar. The amounts of NO₂ measured via the Griess method (Ref. 18), Na₂O via the acid-base method (Ref. 29), and Na₂O₂ via the titanium oxysulfate titration method (Ref. 16). The pristine electrode showed a small amount of NO₂, which was attributed to the electrode preparation process. FIG. 11B shows the charge-discharge profiles of a molten-salt Na—Ar cell at a current density of 1 mA/cm²_{geo} (1^{st} to 5^{th} cycles) with a limited discharge capacity of 2.0 mAh/cm²_{geo} at a temperature of 443 K. FIG. 11C: The Raman spectra of positive electrodes before and after discharge from Na—Ar cells. Raman spectra of commercial Na₂O and NaNO₂, as well as synthetic Na₃ONO₂ as a reference. FIG. 11D shows the discharge profiles of molten-salt Na—O₂ cells with eutectic salt of NaTFSI (31.9 w %)/KTFSI (68.1 w %) in ³²O₂ and Ar at current density of 0.2 mA/cm²_{geo} at temperature of 483 K.

FIG. 12A shows discharge properties of a molten-salt Na—Ar cell with increasing discharge currents from 0.2 mA/cm²_{geo} to 10.0 mA/cm²_{geo}. FIG. 12B shows Coulombic efficiencies of a molten-salt Na—Ar battery at a current density of 1 mA/cm²_{geo} for 5 cycles with a limited discharge capacity of 2.0 mA/cm²_{geo} at the temperature of 443 K.

FIG. 13 shows a CV of a molten-salt Na—Ar cell at scanning rate of 0.2 mV/s in the potential range from 1.2 to 3.0 V. The molten-salt Na—Ar cell contains liquid Na negative electrode, β-Al₂O₃ membrane, Ni/salts positive electrode, Stainless steel (SS) plate. The salts are a mixture of NaNO₃ (26.4 w %), KNO₃ (27.3 w %), and CsNO₃ (46.3 w %).

FIG. 14A shows Raman spectra of Ni/NaNO₃/KNO₃/CsNO₃/SS electrodes with the addition of Na₂O before and after reaction in 412 kPa of Ar or ³²O₂ at 443 K. FIG. 14B shows temperature dependence of changes in the free energies of NaO₂, Na₂O₂, and Na₂O. The free energies calculated based on the following three reactions: 2Na+2O₂→2NaO₂, 2Na+O₂→Na₂O₂, 2Na+½O₂→Na₂O.

FIGS. 15A-15B show Raman spectra of discharged Ni/NaNO₃/KNO₃/CsNO₃/SS electrodes of Na—O₂ cells in ³⁶O₂ and ³²O₂ and DFT calculated Raman spectra. FIG. 15C shows rate of oxygen evolution in 3202, 3402, and ³⁶O₂ as detected by DEMS measurements during charging a symmetric molten-salt Ni/NaNO₃/KNO₃/CsNO₃/SS battery at 0.2 mA/cm²_{geo} to 2.8 V at 443 K in He. Prior to the DEMS measurements, a Na—O₂ cell with Ni/NaNO₃/KNO₃/CsNO₃/SS was discharged to 8 mAh/cm²_{geo} at 0.2 mA/cm²_{geo} and the positive electrode was collected to serve as the counter electrode for the DEMS measurement. In the DEMS experiments, the battery was kept at OCV for 5 hours at 443 K to ensure full melting of the mixture of NaNO₃ (26 w %), KNO₃ (27 w %), and CsNO₃ (47 w %). The electrode geometric area was 0.785 cm²_{geo}. The ratio of 160/180 was ˜3 in the first charging plateau at ˜2.1 V and the ratio increased in the second charging plateau at 2.5 V. The redox potential of nitrate reduction in Ar was ˜1.65 V (vs. Na negative electrode) and was used to convert the measured cell potential to the voltage (vs. Na negative electrode) scale.

FIG. 16 shows Raman spectra of Ni/salts electrodes (8/5 in weight) with the addition of Na₂O before and after reaction in 280 kPa (RT) of ³²O₂ at 443 K. The cells were cooled down with fast (˜20 K/min) and slow rates (1 K/min).

FIG. 17A shows the Raman spectra of pristine and discharged electrode of a molten-salt Na—O₂ cell in ³²O₂ and the standard samples (Na₂CO₃, K₂CO₃, NaTFSI, and KTFSI). FIG. 17B shows the charge/discharge profiles of a molten-salt Na—O₂ cell in ³²O₂ at current density of 0.2 mA/cm²_{geo}. All the above cells were tested at 483 K. The salts in the above cells were a mixture of NaTFSI (31.9 w %)/KTFSI (68.1 w %).

FIG. 18 shows O₂ pressure tracking of the cell after the symmetric molten-salt Na—He battery was discharged for ˜6 mAh. The negative electrode was a Ni/salts electrode discharged in Ar for 8 mAh. The cathode was a pristine Ni/salts electrode. After discharging, the cell was evacuated and purged O₂. The inset showed that the linear fitting of the O₂ consumption rate in the first 3 mins. The electrode geometric area was 0.785 cm²_{geo}. The fitting function is y (mmol)=0.367-0.184*x. Note: salts are the mixture of NaNO₃ (26.4 w %), KNO₃ (27.3 w %), and CsNO₃ (46.3 w %).

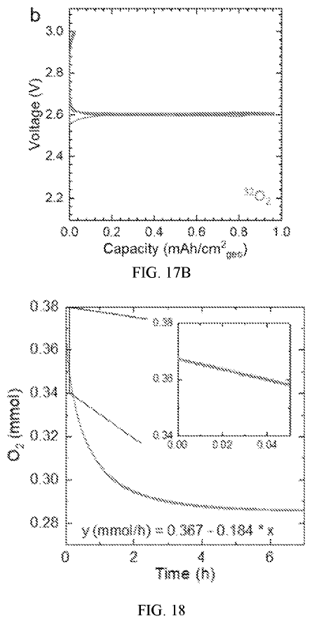

### DETAILED DESCRIPTION

In general, a molten-salt alkali-metal battery includes a first electrode including an alkali metal, an electrolyte (e.g., a solid electrolyte) disposed between the molten alkali metal and a second electrode. The second electrode includes particles having an oxygen-active metal surface and a molten salt including redox-active ions. O₂ is in contact with the second electrode. During discharge, the alkali metal is oxidized at the first electrode and O₂ is reduced at the second electrode. The reverse processes occur during battery charging.

A molten-salt Li—O₂ battery reported by Giordani et al. showed high electrolyte stability and high-energy efficiency (˜95%) at an operating temperature of 423 K. (Ref. 17) The formation of Li₂CO₃ from the oxidation of carbon in the oxygen electrode led to poor cycling stability (<50 cycles, ˜2.6 mAh/cm²_{geo} at ˜0.6 mA/cm²_{geo}, normalized based on the geometric area of the positive electrode). Subsequently, Xia et al. demonstrated a molten-salt Li—O₂ battery with a four-electron conversion using NiO in the oxygen electrode, showing stable cycling performance (150 cycles, 0.5 mAh/cm²_{geo} at 0.2 mA/cm²_{geo}) with a Coulombic efficiency of ˜100%. (Ref. 18) Koo and Kang reported that iron (II,III) oxide can also serve as an effective catalyst to produce Li₂O in nitrate molten-salt Li—O₂ batteries. (Ref. 19) In addition, Zhu et al. reported that Li₂O in nitrate molten-salt Li—O₂ batteries is enabled by the redox activity of nitrate anions and found that NiO has the lowest overpotential during discharge due to its binding of nitrate and nitrite anions. (Ref. 20) Nitrate molten salts have been also used as the O₂ reservoir for a closed Li—O₂ battery system and molten salt electrolytes have also been used with other metal-oxygen batteries besides Li such as Fe, Zn and Mg, showing long cycling life and high rate capability. (Refs. 21-25)

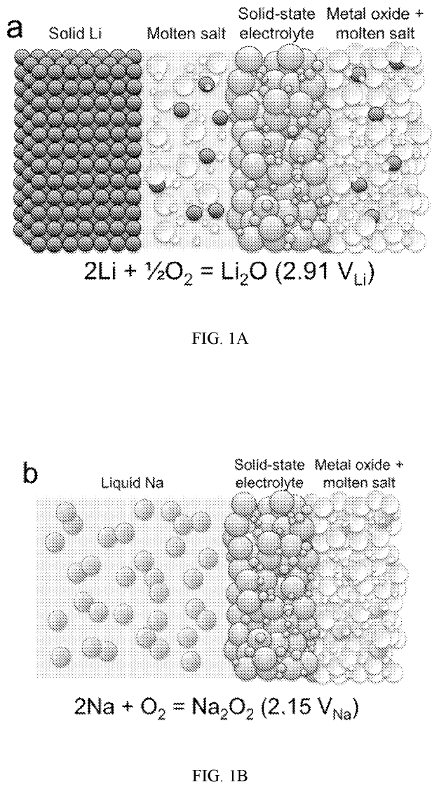

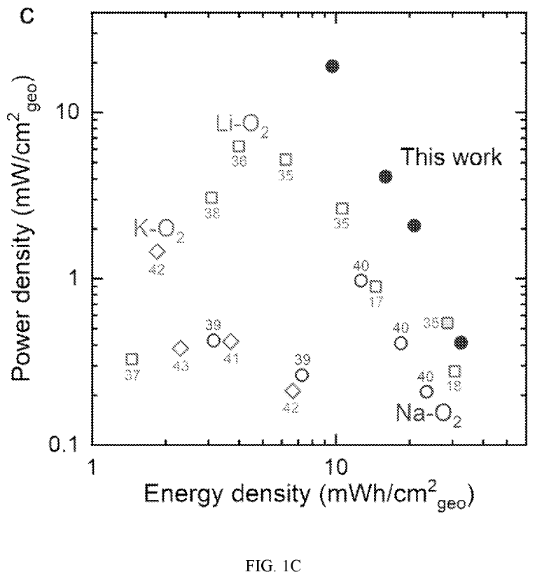

A schematic diagram of a molten-salt Li—O₂ battery is shown in FIG. 1A. Solid-state electrolytes are needed in molten-salt Li—O₂ batteries to prevent crossover of soluble Li₂O that can form due to the reaction between Li metal and the electrolyte. (Ref. 26) A molten-salt buffer layer can be used to provide an interface that efficiently conducts Li⁺ ions between the Li metal electrode and solid-state electrolyte, providing a high rate and energy efficiency in molten-salt Li—O₂ batteries. Replacing Li with Na can increase the power of the system due to low interfacial resistance between liquid Na and the solid-state electrolyte at an operating temperature of 443 K.

Described herein is a molten-salt Na—O₂ battery with a liquid Na electrode, a composite electrode including particles having an oxygen-active metal surface and a molten salt including redox-active ions. A solid-state electrolyte is disposed between the first electrode and the composite second electrode. Oxygen is in contact with the composite second electrode.

An oxygen-active metal surface is a surface including metal atoms that is capable of undergoing redox reactions with oxygen species (e.g., dioxygen, superoxides, peroxides, hydroxides). The oxygen-active metal surface can be the surface of a metal particle (e.g., a solid metal particle, where the metal is capable of undergoing redox reactions with oxygen species, such as a Ni or Cu). The oxygen-active metal surface can include metal oxide sites. For example, a Ni particle can include surface location(s) where oxygen is bound to a Ni atom, e.g., as a hydroxide or oxide. These can be sporadic, individual locations or consistent across the surface. The oxygen-active metal surface can be a surface applied on a substrate material, e.g., as a metal applied (e.g., coated) on a non-oxygen-reactive substrate such as carbon. See., e.g., Zhu et al. (Ref. 20).

Referring to FIG. 1D, battery 10 can include housing 12. Housing 12 can include first electrode 20 and second electrode 25. Between the first electrode 20 and the second electrode 25 is a solid state electrolyte 50. Solid state electrolyte 50 separates liquid metal 40, for example liquid sodium, from metal oxide/molten salt 40. The atmosphere in the housing on the side of the metal oxide/molten salt can include oxygen or a noble gas. The atmosphere can be pressurized and optionally controlled externally to the housing (not shown).

The housing can be an inert metal, for example, stainless steel, platinum or palladium.

Each of the first electrode and the second electrode can be, for example, stainless steel, platinum or palladium.

The liquid metal can be a metal heated to a molten state. The liquid metal can be sodium.

The metal oxide can be formed from metal particles. For example, the metal oxide can include nickel formed from nickel particles.

The molten salt can be a nitrate salt. For example, the molten salt can be a eutectic alkali metal-nitrate mixture, for example, a mixture of two or more of a sodium salt, a potassium salt and a cesium salt. The eutectic alkali metal-nitrate mixture can include between 20 and 50 wt % sodium nitrate. The eutectic alkali metal-nitrate mixture can include between 0 and 60 wt % sodium nitrate. The eutectic alkali metal-nitrate mixture can include between 0 and 70 wt % cesium nitrate. The eutectic alkali metal-nitrate mixture can have a melting point of between 400 K and 500 K.

The solid state electrolyte can be a porous metal oxide. The porous metal oxide can be a refractory metal oxide. In certain embodiments, the porous metal oxide can be an aluminum oxide, for example, beta-aluminum oxide.

In some embodiments, the battery can operate at a temperature above room temperature. For example, the operating temperature can be above 300 K, above 350 K, above 400 K, above 450 K, below 550 K, below 500 K, or below 490 K.

In some embodiments, the battery can operate at a pressure above atmospheric pressure. For example, the operating pressure can be above 1 ATM, above 1.5 ATM, above 2.0 ATM, above 3 ATM, below 8 ATM, below 6 ATM, or below 4 ATM.

In some embodiments, the particles having an oxygen-active metal surface can be metal particles. The metal particles can be Ni particles (e.g., Ni nanoparticles). The redox-active ions can be nitrate (NO₃⁻) ions. The molten salt can be a eutectic molten salt, e.g., including a combination of alkali metal nitrate salts selected from NaNO₃, KNO₃, and CsNO₃. The solid-state electrolyte can be, for example, a β-Al₂O₃ membrane. The membrane can have an average pore size of between 1 micron and 100 microns, for example, 10 microns, 15 microns, 20 microns, 25 microns, 30 microns, 35 microns, 40 microns, 45 microns, 50 microns, 55 microns, 60 microns, 65 microns, 70 microns, 80 microns, 85 microns, 90 microns, or 95 microns.

The battery can be operated at a predetermined operating temperature selected to maintain Na in the liquid state and the molten salt in the molten state.

In some embodiments, the battery can provide an areal energy density of at least about 10 mWh/cm²_{geo}, at least about 20 mWh/cm²_{geo}, at least about 30 m Wh/cm²_{geo}, at least about 33 mWh/cm geo, or greater. In certain embodiments, the battery can provide an areal energy density of less than 100 mWh/cm²_{geo}, less than 90 mWh/cm²_{geo}, less than 80 mWh/cm²_{geo}, less than 75 mWh/cm²_{geo}, less than 70 mWh/cm²_{geo}, less than 65 mWh/cm²_{geo}, less than 60 mWh/cm²_{geo}, less than 55 m Wh/cm²_{geo}, less than 50 mWh/cm²_{geo}, less than 45 mWh/cm²_{geo}, or less than 40 mWh/cm²_{geo}.

In some embodiments, the battery can provide an areal power density of at least about 8 mW/cm²_{geo}., at least about 10 mW/cm²_{geo}, at least about 15 mW/cm²_{geo}, at least about 19 mW/cm²_{geo}, or greater. In certain embodiments, the battery can provide an areal power density of less than about 60 mW/cm²_{geo}, less than about 50 mW/cm²_{geo}, less than about 40 mW/cm²_{geo}, or less than about 30 mW/cm²_{geo},

In some embodiments, the battery can provide stable cycling of greater than 150 cycles, e.g., at least about 200 cycles, at least about 250 cycles, at least about 300 cycles, at least about 400 cycles, or greater. In some embodiments, the battery can provide stable cycling of less than 5000 cycles, e.g., less than about 4000 cycles, less than about 3000 cycles, less than about 2000 cycles, or less than about 1000 cycles.

In some embodiments, the battery can provide an energy efficiency of at least about 50%, at least about 60%, at least about 70%, at least about 80%, at least about 85%, or greater. In certain embodiments, the battery can provide an energy efficiency of less than about 100%, less than about 98%, less than about 95%, or less than about 90%.

Described herein is are certain embodiments of a molten-salt Na—O₂ battery with a liquid Na negative electrode, a Ni oxygen electrode with a NaNO₃/KNO₃/CsNO₃ eutectic electrolyte, and a β-Al₂O₃ membrane. A schematic is shown in FIG. 1B. The stable interface between liquid Na and β-Al₂O₃ can be advantageous relative to molten-salt Li—O₂ batteries. (Ref. 27). See FIG. 1B. The molten-salt Na—O₂ batteries described herein provide high energy density (e.g., 33 mWh/cm²_{geo}), high power density (e.g., 19 mW/cm²_{geo}), and stable cycling (e.g., 400 cycles, 0.5 mAh/cm²_{geo} at 5 mA/cm²_{geo}).

As described in the Examples below, in some embodiments, an energy density of 33 mWh/cm²_{geo}, a power density of 19 mW/cm²_{geo}, and cycling stability of 400 cycles with 0.5 mAh/cm²_{geo} at 5 mA/cm²_{geo}, can be achieved. It should be noted that these figures are examples and not to be considered limiting. In the batteries of the present disclosure, the dominant discharge product is Na₂O₂, as shown using Raman, pressure tracking and titration measurements (see Examples below). Moreover, the redox of nitrate anions can be important for the formation of Na₂O₂ upon discharge. Molten-salt Na—Ar cells show the electrochemical reduction of NaNO₃ to Na₂O and NaNO₂. On the other hand, in an O₂ environment the formed Na₂O and NaNO₂ can further react with O₂ to yield Na₂O₂ and regenerate NaNO₃, respectively. Finally, using ¹⁸O-labeling experiments, the oxygen reduction reaction in molten-salt Na—O₂ batteries was demonstrated to occur via a nitrate-mediated mechanism whereby NaNO₃ facilitates an apparent 2e⁻/O₂ overall reaction to form Na₂O₂. The present molten-salt Na—O₂ batteries provide an approach to alkali metal-O₂ batteries with high energy and power densities and use a cell architecture that can stabilize the alkali metal electrode.

### Examples

### Materials

Nickel metal powder (325 mesh, 99.8%, Fisher Scientific Co. LLC.) was used for electrode preparation. NaNO₃ (99.999%, Fisher Scientific Co. LLC.), KNO₃ (99.99%, Fisher Scientific Co. LLC.), CsNO₃ (99.99%, Fisher Scientific Co. LLC.), NaNO₂ (>97%, Fisher Scientific), NaTFSI (sodium trifluoromethanesulfonimide, 97%, Sigma Aldrich), KTFSI (potassium trifluoromethanesulfonimide, 97%, Sigma Aldrich) were used to prepare the eutectic molten-salt electrolytes and electrodes. Na β-Al₂O₃ discs (Ionotec Ltd.) were used as Na-ion conductors for molten-salt Na—O₂ batteries. Na₂O₂ (97%, Sigma Aldrich), NaO₂ (Thermo Scientific™), Na₂CO₃ (99.5%, Sigma Aldrich) and K₂CO₃ (99.0%, Sigma Aldrich) were used as standard samples for Raman spectra. Standardized titanium (IV) oxysulfate solution (Aldrich, ˜15 wt % in dilute sulfuric acid, 99.99% trace metals basis) was used to quantify Na₂O₂ in discharged electrodes. (Ref. 28) Hydrochloric acid (0.01 N, VWR) was used for acid-base titration experiments for Na₂O and Na₂O₂ from discharged electrodes. (Refs. 29-30) Griess reagent system (Promega) was used for nitrite titration for discharged electrodes. (Ref. 18)

Preparation of the Ni/NaNO₃/KNO₃/CsNO₃ Electrodes

2 g of Ni powder (325 mesh, 99.8%, Fisher Scientific Co. LLC.) was added into 5 mL of a NaNO₃ (26.4 w %)/KNO₃ (27.3 w %)/CsNO₃ (46.3 w %) solution (0.25 g/mL in Deionized water, (DIW). Then the above suspension was sonicated for 10 mins and transferred into an oven for drying at 453 K for 2 hours. Next, the composite powder was ground for half an hour and pressed as an electrode (0.2 g and 12.7 mm of diameter) onto stainless steel mesh (120 mesh) with 2 tons of pressure for 1 min in an Ar-filled glove box. These electrodes were transferred into a vacuum Buchi glass oven at 473 K for two days and then stored in an argon-filled glove box. After preparation, there was a small amount of NO₂ in the Ni/NaNO₃/KNO₃/CsNO₃ electrodes, which can be attributed to at least one of the following reactions (Ref. 31): Ni+NaNO₃→NiO+NaNO₂ (ΔG⁰=−128.7 KJ/mol), Ni+KNO₃→NiO+KNO₂ (ΔG⁰=−122.8 KJ/mol) or Ni+CsNO₃→NiO+CsNO₂ (ΔG⁰=−118.4 kJ/mol). Values of AGO are taken from Table 1.

TABLE 1
Thermodynamic data

| | Δ_{f}H⁰ | S⁰ | Cₚ | Δ_{f}G⁰ |
|---|---|---|---|---|
| Compound | (kJ/mol) | (J/mol · K) | (J/mol · K) | (kJ/mol) |
| Na | 0 | 51.3 | 28.2 | 0 |
| NaO₂ | −260.2 | 115.9 | 72.1 | −218.4 |
| Na₂O₂ | −510.9 | 95.0 | 89.2 | −447.7 |
| Na₂O | −414.2 | 75.1 | 69.1 | −375.5 |
| NaNO₂ | −358.7 | 103.8 | NA | −284.6 |
| NaNO₃ | −467.9 | 116.5 | 92.9 | −367.0 |
| KNO₂ | −369.8 | 152.1 | 107.4 | −306.6 |
| KNO₃ | −494.6 | 133.1 | 96.4 | −394.9 |
| K₂O₂ | −495.4 | 110.1 | 95.8 | −428.4 |
| CsNO₂ | NA | NA | NA | −313.8 |
| CsNO₃ | −506.0 | 155.2 | NA | −406.5 |
| Cs₂O₂ | NA | NA | NA | −327.0 |
| NiO | −239.3 | 38.0 | 67.7 | −211.1 |
| O₂ | 0 | 205.2 | 29.4 | 0 |
| Ni | 0 | 29.9 | 26.1 | 0 |

Refs. 69-74.

### Preparation of Ni/NaTFSI/KTFSI Electrodes

2 g of Ni powder (325 mesh, 99.8%, Fisher Scientific Co. LLC.) was added into 5 mL of a NaTFSI (31.9 w %)/KTFSI (68.1 w %) solution (0.25 g/mL in DIW). Then the above suspension was sonicated for 10 mins, transferred into an oven, and dried at 453 K for 2 hours. Next, the composite powder was ground for half an hour and compressed as a 12.7 mm electrode (0.2 g) on stainless steel mesh (120 mesh) with 2 tons of pressure for 1 min in an Ar-filled glove box. These electrodes were transferred into a vacuum Buchi glass oven at 473 K for two days and then stored in an Ar-filled glove box for use.

### Synthesis of Na₃ONO₂

Na₂O (Fisher Scientific) and NaNO₂ (>97%, Fisher Scientific) with a 1:1 molar ratio was ground for 20 mins, and then 50 mg of the mixture was pressed as a pellet. After that, the pellets were sealed in an air-tight stainless-steel (SS) reactor under an Ar environment. The reactor was put in the oven at 573 K for 20 h. The produced yellow pellet (Na₃ONO₂) was transferred into an Ar-filled glove box for characterization.

### Assembly of Na Molten-Salt Cells

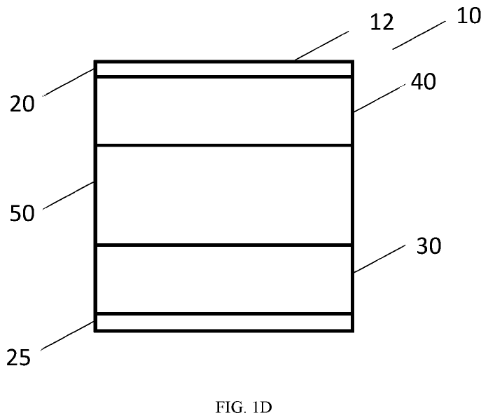

All parts of Na—O₂ cells were dried in a vacuum oven at 353 K for 12 h before use. The liquid Na negative electrode and the Ni/salts positive electrode (12.7 mm in diameter) were separated by a piece of β-Al₂O₃ conductor. A schematic structure of the Na molten-salt cell is shown in the inset of FIG. 2A. After assembly, the cells were charged with O₂ or Ar. The charged O₂ or Ar pressure ranged from ˜70 to 280 kPa at room temperature. There was good wetting between liquid Na and β-Al₂O₃ membrane after resting for 2 hours in Na—O₂ cells.

Characterization of the Reaction Between Na₂O and O₂

10 mg of Na₂O was added to 200 mg of Ni/salt powder (8/5 weight ratio) and then pressed as a pellet under a pressure of 2 tons. After that, the pellet was put into an air-tight cell with 275 kPa of O₂ or Ar at 443 K for 48 h. After the reaction, the pellet was characterized in an air-tight cell using Raman spectroscopy.

Quantification of the Solubility of Na₂O₂ in Molten Salts

The solubility of Na₂O₂ in a eutectic molten salt (composition: NaNO₃ (26.4 w %)/KNO₃ (27.3 w %)/CsNO₃ (46.3 w %)) was measured via an acid-base titration method. 2 w % of Na₂O₂ in the above molten salts was stirred at 443 K for two days, and then allowed to rest for three days at the same temperature. After that, the top, clear molten salt was collected for acid-base titration.

### Electrochemical Measurements

Molten-salts Na—O₂ cells were measured on a temperature-controlled hot plate. The temperature was set at 443 K. The operation voltage window was set between 1.8 and 2.8 V. The applied current density ranged from 0.1 to 10 mA/cm²_{geo}. The battery tests were conducted using a Biologic VMP3 electrochemical workstation. The areal capacity, energy density and power density obtained from the electrochemical measurements were normalized by the area of the positive electrode.

### Differential Electrochemical Mass Spectrometry

Differential electrochemical mass spectrometry (DEMS) measurements were conducted on a custom-made DEMS setup which was detailed previously.³² The isotopic compositions of O₂ were: ³²O₂ (¹⁶O¹⁶O), ³⁴O₂ (¹⁶O¹⁸O), and ³⁶O₂ (¹⁸O¹⁸O), which were detected during charging with 10 min of accumulation time for each point. O₂ pressure was measured during the discharge process to quantify the O₂ consumption. Helium (Ultra High Purity 5.0 Grade, Airgas) was used as the carrier gas in DEMS measurements. The effective area of electrodes was 0.785 cm² for DEMS measurement. The operation temperature was 443 K. The applied discharge and charge current densities ranged from 0.1 to 0.4 mA/cm²_{geo}.

### Quantification of Discharge Products

NO₂⁻ was quantified using the Griess method.¹⁸ NO₂⁻ titration was conducted on a UV-Vis spectrophotometer (Genesys 180, Thermo Fisher Scientific). The NO₂ calibration curve was generated using titration of the standard NO₂ solutions (0, 0.01, 0.02, 0.05, 0.1, 0.5, 1 mM). 50 μL of standard NO₂ solution and 50 μL of sulfanilic acid (10 mg/mL solution in 5% phosphoric acid, Promega) were added into a 1.2 mL plate deep well and then was kept in a dark environment for 3-5 mins. Next, 50 μL of N-(1-naphthyl)ethylenediamine dihydrochloride (1 mg/mL) solution (Promega) was added to the above solution and was kept in a dark environment for another 3-5 mins. After that, 100 μL of the above solution was transferred into a quartz cuvette (10 mm path length, VWR) with 1.9 mL of deionized water (DIW). The solution in the cuvette was tested immediately using UV-Vis with a scanning rate of 1 nm/s from 450 to 700 nm. The curve of absorbance vs. NO₂ concentration was linearly fit. For quantification of electrodes, the samples were dispersed in 50 mL of DIW, and then a clear solution was obtained by centrifugation. The clear solution was diluted ranging from 1/50 to 1/100. The diluted solution was then titrated using the above procedure.

Na₂O₂ was quantified using titanium oxysulfate titration. Discharged electrodes were extracted from discharged molten salt Na—O₂ or Na—Ar cells in an Ar-filled glove box. Then, the electrode was removed from the glovebox and immediately dispersed in 50 mL of cooled DIW (stored in a refrigerator at 278 K) and stirred for 4 mins. During this time, the following reaction occurred: Na₂O₂+2H₂O→2 NaOH+H₂O₂. There is a side reaction Na₂O₂+H₂O→2NaOH+0.502, which can be neglected based on literature findings. (Ref. 28). Next, 1 mL of the solution was filtered using a 0.2 μm filter and was added to 1 ml of cooled DIW and titrated with 0.5 ml. standardized titanium (IV) oxysulfate solution (Aldrich, ˜15 wt % in dilute sulfuric acid, 99.99% trace metals basis). This step allows the fast reaction between H₂O₂ and Ti⁴⁺ oxysulfate to form yellow pertitanic acid. The reaction is Ti⁴⁺+H₂O₂+2H₂O→H₂TiO₄+4H⁺. The concentration of the yellow pertitanic acid was determined using UV-vis spectroscopy (Genesys 180, Thermo Fisher Scientific) with a scanning rate of 1 nm/s from 350 to 650 nm. The UV-vis spectra of the titration of standardized H₂O₂ solutions (Certified ACS 31.7%, Fisher Chemical) was calibrated at various concentrations (0.08, 0.2, 0.4, 0.8, 1.2, 1.6 mM).

Acid-based titrations for Na₂O quantification were done using a pH meter (PH 700 meter, VWR) and 0.01 N of HCl standard solution (VWR). All discharged electrodes were first dispersed in 20 mL of DIW, and then clear solutions were collected via centrifugation and filtration using a 0.2 μm filter. The reaction of Na₂O in the electrode and DIW is Na₂O+H₂O═2NaOH. (Ref. 22) 1 ml, of the filtered solution was diluted to 10 ml for acid-base titration. The titration reaction is NaOH+HCl=NaCl+H₂O. (Ref. 21) The end point of the titration was determined by the pH reaching ˜7 (6.5-7.5). In the event that Na₂O₂ was detected, the contribution from Na₂O₂ was deducted from the value determined from acid-base titration to determine the contribution from Na₂O.

### Characterization of Electrodes

Ni electrodes were characterized through X-ray diffraction (XRD, Bruker D2), scanning electronic microscopy (SEM, Zeiss Merlin), and Raman spectroscopy (HORIBA Scientific LabRAM HR800). In the measurements of XRD and Raman spectra, the electrodes were sealed in air-tight cells. In XRD measurements, the applied voltage and current were 30 kV and 10 mA, respectively, using Cu-Kα radiation (2=1.54178 Å). In the Raman spectra measurements, a red laser (λ=632.8 nm) was used with 50-fold magnification. An exposure time of 15 s with a 600 grating was used, and each spectrum was accumulated five times.

### Electrochemical Performance of Molten-Salt Na—O₂ Cells

Molten-salt Na—O₂ cells discharged at 443 K exhibited discharge voltages of 1.9-2.1 V at rates up to 10 mA/cm²_{geo}, where the cells were constructed with a liquid Na negative electrode, a β-Al₂O₃; membrane, and Ni/NaNO₃/KNO₃/CsNO₃/stainless steel (SS) oxygen electrode (inset of FIG. 2A). A ternary NaNO₃ (26.4 w %)/KNO₃ (27.3 w %)/CsNO₃ (46.3 w %) eutectic molten-salt electrolyte was selected due to its lower melting temperature (427 K, onset around 417 K) compared to the binary eutectics NaNO₃/KNO₃ (494 K) and NaNO₃/CsNO₃ (464 K) binary eutectics (Table 2). Critically, all three nitrate salts show thermal stability up to 600 K (Ref. 33), which is significantly higher than the operating temperature of 443 K used herein.

TABLE 2
Melting points of nitrate eutectic salts for Na—O₂ batteries

| | | | Melting | |
|---|---|---|---|---|
| NaNO₃ (w %) | KNO₃ (w %) | CsNO₃ (w %) | point (K) | Reference |
| 45.7 | 54.3 | — | 494 | Ref. 68 |
| 35.7 | — | 64.3 | 464 | Ref. 68 |
| 26.4 | 27.3 | 46.3 | 427 | Ref. 68 |

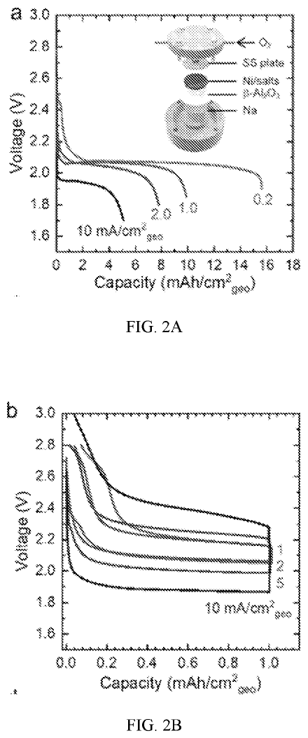

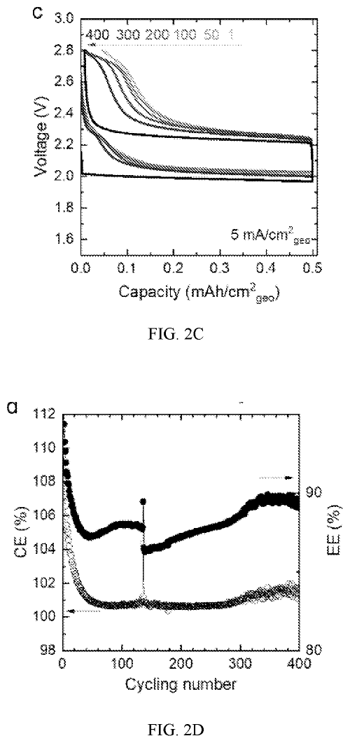

By investigating different weight ratios of Ni to NaNO₃/KNO₃/CsNO₃ salts, an optimal ratio of 8/5 was identified, which yielded a discharge capacity of ˜16 mAh/cm²_{geo} at 0.2 mA/cm²_{geo} (FIG. 3). Increasing current density from 0.2 to 10 mA/cm²_{geo} was accompanied by an exponential decrease in areal capacity suggesting that the discharge process could be limited by O₂ diffusion at high rates (FIG. 2A and FIG. 4). On the other hand, the discharge voltages decreased linearly with increasing current densities in FIG. 2A and FIG. 4, which was consistent with the overpotential being governed by the cell's resistance of ˜10Ω from the slope in FIG. 4.

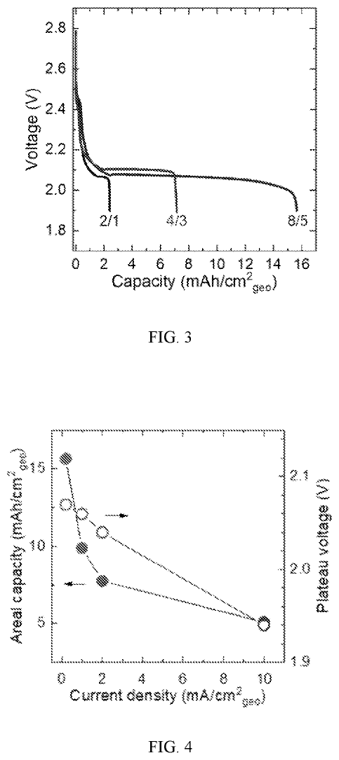

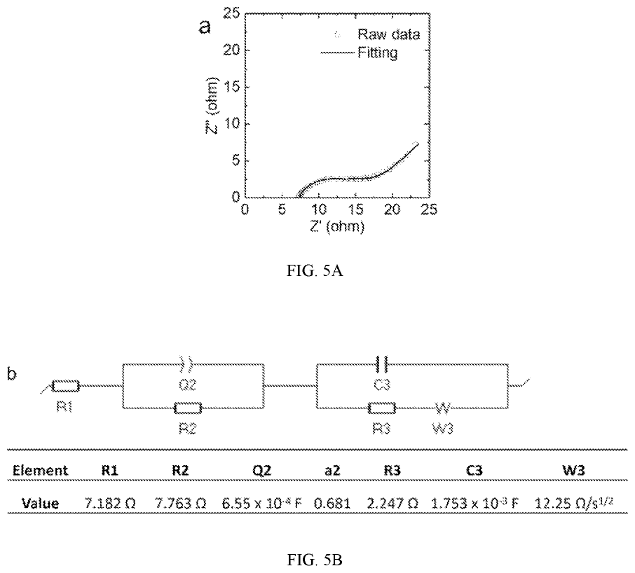

Further support came from electrochemical impedance spectroscopy (EIS) in FIGS. 5A-5B, which revealed low ohmic resistance (R1) of ˜7Ω, charge transfer resistance between β-Al₂O₃ and the electrodes (R2) of ˜8Ω, and low ionic resistances from β-Al₂O₃(R3) of ˜2Ω. These resistances add up to a total cell resistance of ˜17Ω which is similar in magnitude to the slope of discharge voltage vs. current from FIG. 4 (˜10Ω). Moreover, galvanostatic intermittent titration technique (GITT) measurements in FIG. 6A, showed small overpotentials (<10 mV, inset) for the discharge plateau, with 3-4 mV of the overpotentials came from charge/discharge IR drop (FIGS. 6A-6C). Remarkably, these results suggest fast oxygen redox kinetics in molten-salt Na—O₂ cells contrast to reported room temperature Na—O₂ batteries using organic aprotic solvents for the electrolytes and carbon nanotube electrodes³⁴ which had a discharge overpotential of ˜1 V at a rate of 1 mA/cm²_{geo}.

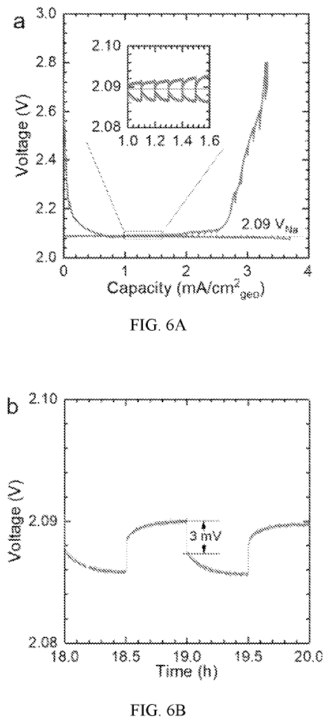

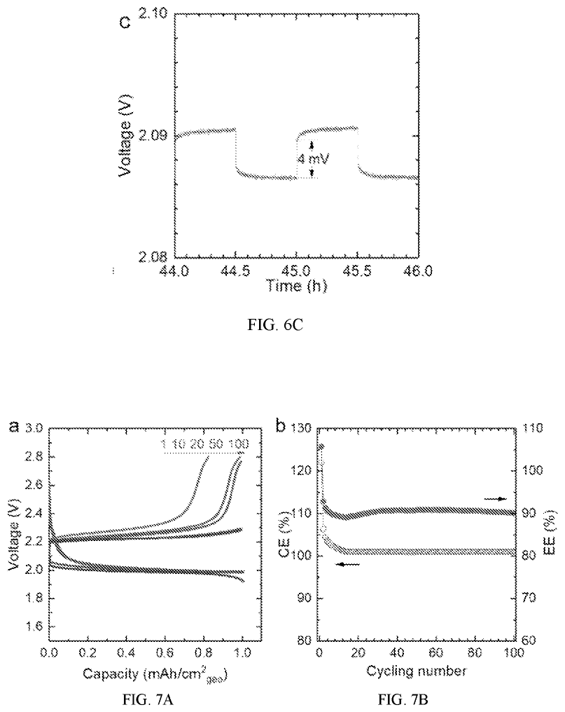

Molten-salt Na—O₂ cells also demonstrated low overpotentials during charging, as well as high cycling stability (400 cycles), and high Coulombic (˜100% at 5 mA/cm²_{geo}) and energy (˜90% at 5 mA/cm²_{geo}) efficiencies. Molten-salt Na—O₂ cells were discharged and charged with capacities limited to 1 mAh/cm²_{geo} at rates from 1 mA/cm²_{geo} to 10 mA/cm²_{geo} (FIG. 2B). Remarkably, even at high rates of 10 mA/cm²_{geo}, the overpotential on charge remained small (<300 mV) for most of the charging process, only increasing sharply after 0.8 mAh/cm²_{geo}-Moreover, molten-salt Na—O₂ cells could be stably cycled at 5 mA/cm²_{geo} to 0.5 mAh/cm²_{geo} for 400 cycles (FIG. 2C) with negligible increase in overpotential, as well as stable Coulombic (CE) and energy efficiencies (EE) of ˜100% and ˜91%, respectively (FIG. 2D). Moreover, increasing the cut-off capacity during cycling to 1.0 mAh/cm²_{geo}, the molten-salt Na—O₂ cell still showed low overpotentials, long cycling life (100 cycles), and high CE (˜100%) and EE (˜90%) (FIG. 7). Such molten-salt Na—O₂ cells exhibited higher energy (33 mWh/cm²_{geo}) and power densities (19 mW/cm²_{geo}) as compared with even the highest performing nonaqueous Na—O₂ cells with 24 mWh/cm²_{geo} and 1.0 mW/cm²_{geo} (Ref. 40). Significantly, when compared to reported Li—O₂ batteries (Refs. 18 and 36), these molten-salt Na—O₂ cells can also provide comparable areal energy density (33 m Wh/cm²_{geo} vs. 30 mWh/cm²_{geo} (Ref. 18)) and higher areal power density (19 mW/cm²_{geo} VS. 6 mW/cm²_{geo} (Ref. 36)) than the highest performing cells reported to date. Please see FIG. 1C, FIG. 8, and Table 3 for a detailed comparison of the reported performance of alkali metal-oxygen batteries vs. the molten-salt Na—O₂ cells reported herein.

TABLE 3
Detailed performance characteristics of reported Li—O₂, Na—O₂, and K—O₂ batteries

| | Discharge | | | | | |
|---|---|---|---|---|---|---|
| | voltage | Current | Capacity | Energy density | Power density | |
| System | (V) | (mA/cm²_{geo}) | (mAh/cm²_{geo}) | (mWh/cm²_{geo}) | (mW/cm²_{geo}) | Reference |
| Li—O₂ | 2.7 | 0.2 | 10.6 | 28.62 | 0.54 | ¹ |
| | 2.65 | 1 | 4 | 10.6 | 2.65 | ¹ |
| | 2.6 | 2 | 2.4 | 6.24 | 5.2 | ¹ |
| | 2.78 | 0.1 | 11 | 30.58 | 0.278 | ² |
| | 2.8 | 0.32 | 5.2 | 14.56 | 0.896 | ³ |
| | 2.5 | 2.5 | 1.6 | 4 | 6.25 | ⁴ |
| | 2.55 | 0.129 | 0.57 | 1.4535 | 0.32895 | ⁵ |
| | 2.7 | 1.142 | 1.142 | 3.0834 | 3.0834 | ⁶ |
| Na—O₂ | 2.2 | 0.12 | 3.3 | 7.26 | 0.264 | ⁷ |
| | 2.13 | 0.2 | 1.48 | 3.1524 | 0.426 | ⁷ |
| | 2.1 | 0.1 | 11.2 | 23.52 | 0.21 | ⁸ |
| | 2.05 | 0.2 | 9 | 18.45 | 0.41 | ⁸ |
| | 1.95 | 0.5 | 6.5 | 12.675 | 0.975 | ⁸ |
| K—O₂ | 2.1 | 0.2 | 1.76 | 3.696 | 0.42 | ⁹ |
| | 2.4 | 0.16 | 0.96 | 2.304 | 0.384 | ¹¹ |
| | 2.4 | 0.0885 | 2.77 | 6.648 | 0.2124 | ¹⁰ |
| | 2.2 | 0.664 | 0.84 | 1.848 | 1.4608 | ¹⁰ |
| *Cell | 1.9 | 10 | 5.09 | 9.671 | 19 | |
| described | 2.06 | 2 | 7.75 | 15.965 | 4.12 | |
| herein | 2.09 | 1 | 10 | 20.9 | 2.09 | |
| | 2.07 | 0.2 | 15.7 | 32.499 | 0.414 | |

### Discharge Products of Molten Salt Na—O₂ Cells

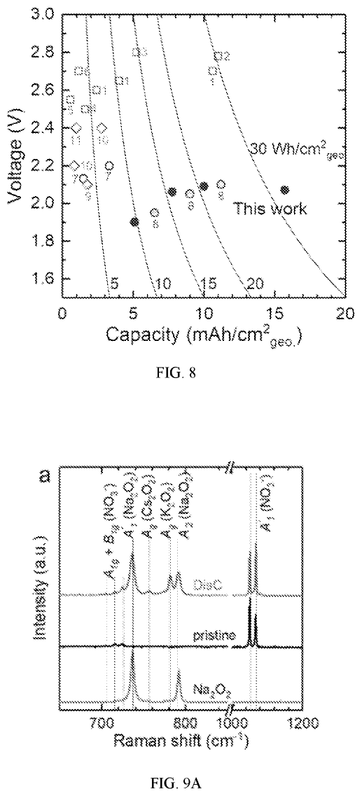

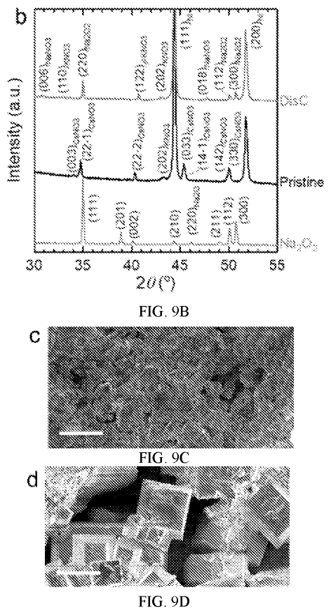

The discharge of molten-salt Na—O₂ cells mainly produces Na₂O₂. Discharge of Ni/NaNO₃/KNO₃/CsNO₃/SS electrodes was accompanied by the emergence of four Raman bands from 700 to 800 cm⁻¹, which can be assigned to the O—O stretching vibration (FIG. 9A). For instance, the Raman bands at 737 and 792 cm⁻¹ are consistent with those reported for the A₁′ and A₂′ vibration modes of Na₂O₂ (Ref. 44), while those at 756 and 781 cm⁻¹ can be attributed to O—O stretching of Cs₂O₂ (Ag mode) (Ref. 45) and K₂O₂ (Ag mode) (Ref. 44), respectively. The presence of K₂O₂ and Cs₂O₂ was unexpected because it is thermodynamically uphill to replace the Na⁺ ions in Na₂O₂ with K⁺ (Na₂O₂+2KNO₃→K₂O₂+2NaNO₃, ΔG=75.1 KJ/mol) or Cs⁺ (Na₂O₂+2CsNO₃→Cs₂O₂+2NaNO₃, ΔG=199.7 KJ/mol) from the molten nitrate electrolyte (see below for calculation details). The K₂O₂ and Cs₂O₂ observed in the discharged electrode likely came from soluble O₂²⁻ in the molten-salt electrolyte that, upon cooling of the electrodes, became kinetically trapped out of equilibrium. This hypothesis is in agreement with the Raman spectra of an electrode that was cooled slowly (˜1 K/min), which showed very weak Raman bands for K₂O₂ and Cs₂O₂. Interestingly, Raman spectra of discharged electrodes that had not been washed in aprotic solvents between discharge and characterization showed evidence of some Na₂O formation (discussed below). Further support that the dominant discharge product was Na₂O₂ came from XRD patterns of washed, discharged electrodes (FIG. 9B) that showed clear peaks from Na₂O₂ ((220), (112), and (300)), but none from K₂O₂ or Cs₂O₂ or Na₂O, where small amounts of amorphous Cs₂O₂ and K₂O₂ formed during cooling of the electrode would not be detectable using XRD. SEM images (FIGS. 9C-9D) reveal Na₂O₂ large faceted crystals (5 to 30 μm) produced in the discharged electrode, which may be attributed to the high solubility of Na₂O₂ (65 mM) in NaNO₃/KNO₃/CsNO₃ molten-salts.

Calculation of equilibrium potentials of Na—O₂ batteries Citations for all thermodynamic values can be found in Table 1. Δ_{f}G^{443K} was calculated using:

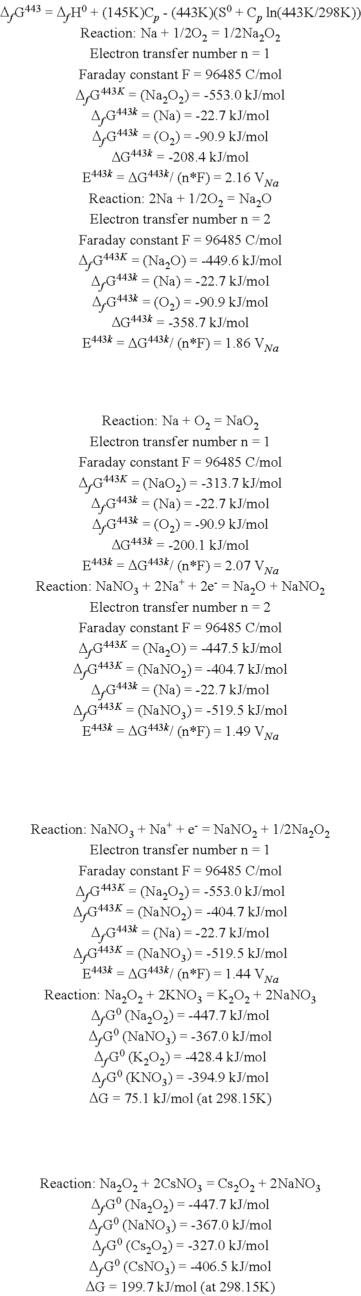

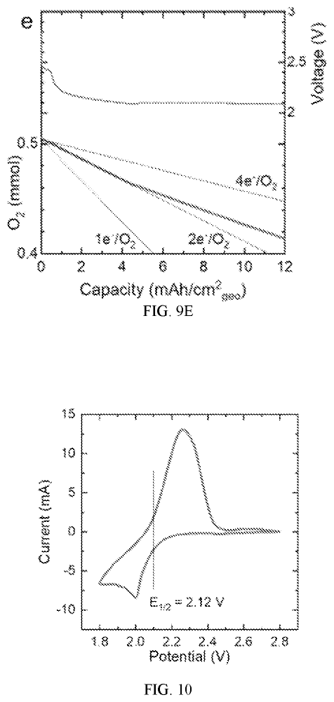

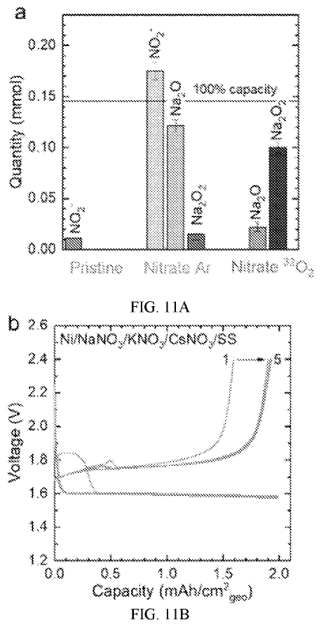

The formation of Na₂O₂, as well as some Na₂O during discharge of molten-salt Na—O₂ cells is further supported by the equilibrium potential from cyclic voltammogram (CV) measurements as well as pressure tracking and titration measurements. CVs collected using a molten-salt Na—O₂ cell at 0.2 mV/s (FIG. 10) showed a cathodic peak at 2.00 V, and anodic peak at 2.26 V. Significantly, the equilibrium potential estimated by E_{1/2} was 2.12 V, which is similar to that obtained from GITT measurements ˜2.09 V (FIG. 6A), as well as the calculated thermodynamic potential of the 2Na++O₂+2e⁻→Na₂O₂ at 443 K (2.15 VNa), but different from the formation NaO₂ (2.07 VNa) and Na₂O (1.86 VNa), in agreement with the overall reaction being the formation of Na₂O₂ from O₂. Interestingly, pressure tracking measurements (FIG. 9E) of molten-salt Na—O₂ cells during discharge showed two distinct regions corresponding to a 2.0 e⁻/O₂ process at early discharge (0-4.5 mAh/cm²_{geo}) and a 2.8 e⁻/O₂ process later in discharge (4.5-12 mAh/cm²_{geo}). The transition between the 2.0 e⁻/O₂ and 2.8 e⁻/O₂ processes at a discharge capacity of ˜4.5 mAh/cm²_{geo} was accompanied by a transition from a sloped discharge voltage profile to a flat voltage profile once the discharge voltage reached ˜2.10 V. While the 2.0 e⁻/O₂ in early discharge is consistent with the formation of Na₂O₂, the 2.8 e⁻/O₂ process later in discharges suggests the formation of both Na₂O₂ (2 e⁻/O₂) and Na₂O (4 e⁻/O₂). The origin of these two regions during cell discharge will be discussed later. Further evidence that the discharge product contained both Na₂O₂ and Na₂O came from quantifications of a Ni/NaNO₃/KNO₃/CsNO₃/SS electrode discharged to 6.0 mAh/cm²_{geo} via the Griess method (Ref. 18), Ti (IV) oxysulfate (Ref. 16), and acid-based titrations (Ref. 29). As shown in FIG. 11A, the pristine Ni/NaNO₃/KNO₃/CsNO₃/SS electrode showed only a small amount of NO₂ (11.7 μmol), which may come from a chemical reaction between Ni and nitrate salts, but no Na₂O₂ and Na₂O. On the other hand, following discharge, there was no NO₂⁻, but instead 22.2 μmol of Na₂O and 99.9 μmol of Na₂O₂ were detected, which combined, accounts for 5.2 mAh/cm²_{geo} comparable to the actual capacity of 6.0 mAh/cm²_{geo}.

### Nitrate Anions are Redox Active in Molten-Salt Na—O₂ Batteries

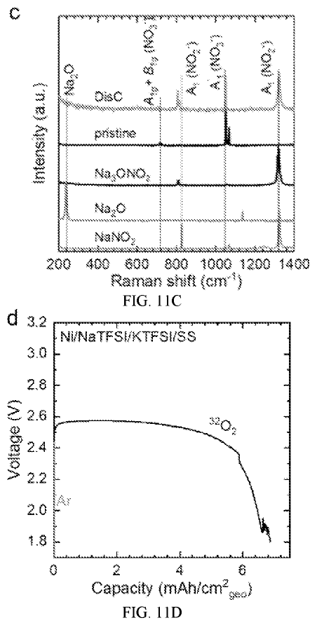

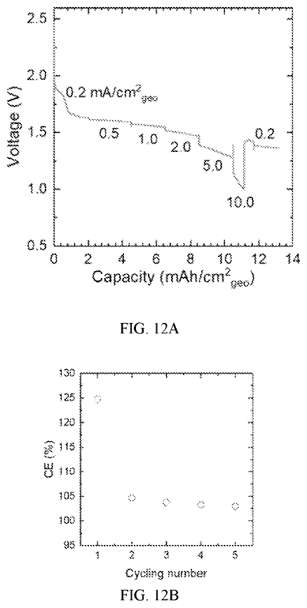

Discharging Ni/NaNO₃/KNO₃/CsNO₃/SS electrodes in Na—Ar cells resulted in the formation of Na₃ONO₂ (from equimolar Na₂O and NaNO₂) with a discharge voltage of ˜1.6 V. Ni/NaNO₃/KNO₃/CsNO₃/SS electrodes could be discharged to capacities of >12 mAh/cm²_{geo} in Na—Ar cells (FIG. 12). Na—Ar cells with Ni/NaNO₃/KNO₃/CsNO₃/SS electrodes could be discharged stably at rates up to 5 mA/cm²_{geo} and after the first cycle, could be cycled with Coulombic efficiency (CE) of ˜104% for 5 cycles (FIG. 11B). Raman spectra of the discharged electrode (FIG. 11C) showed bands at 810, 1056, 1064, 1319 cm⁻¹ which are consistent with those of Na₃ONO₂. Na₃ONO₂ is an adduct of equimolar Na₂O and NaNO₂, and can be readily formed from the reaction between Na₂O and molten NaNO₂ at elevated temperatures. (Ref. 48) CV measurements of Na—Ar cells (FIG. 13) showed a cathodic peak at 1.46 V and anodic peak at 1.89 V, corresponding to an equilibrium potential of ˜1.68 V, which is in good agreement with the thermodynamic potential of NaNO₃+2Na⁺+2e⁻→Na₂O+NaNO₂ at 443 K (E°=1.49 V). Further support that the discharge of Ni/NaNO₃/KNO₃/CsNO₃/SS electrodes in Na—Ar cells forms equimolar Na₂O and NaNO₂ came from titration measurements that showed 175.0 μmol of NaNO₂, 121.7 μmol of Na₂O and 15.4 μmol of Na₂O₂ (FIG. 4a), which combined, corresponds to a discharge capacity of 5.77 mAh/cm²_{geo} and is close to the actual capacity of 6.0 mAh/cm²_{geo}. The small amount of Na₂O₂ can be attributed to the direct formation of Na₂O₂ from NaNO₃ given by NaNO₃+Na++e→NaNO₂+½Na₂O₂ with E°=1.44 VNa at 443 K. The redox activity of nitrate anions in molten-salt Na—Ar cells is in agreement with recent work on molten-salt Li—Ar cells. (Ref. 49)

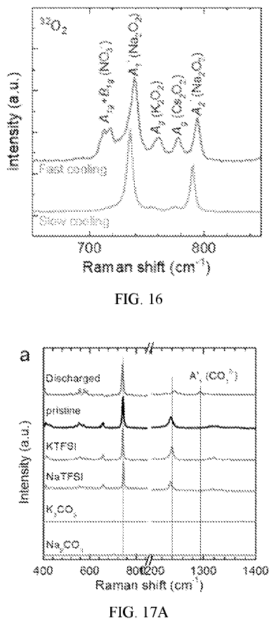

The presence of redox active (e.g., nitrate) anions in the electrolyte was essential to enable molten-salt Na—O₂ cells that formed Na₂O₂ during discharge. Given the observed redox activity of nitrate anions in molten salt Na—Ar cells, molten-salt cells were constructed where nitrate anions were replaced with redox inactive bis(trifluoromethanesulfonyl)imide anions (TFSI) by using NaTFSI/KTFSI (31.9/68.1 w %) eutectic salt (Ref. 50) with a melting temperature of 453 K as the electrolyte. The redox inactivity of TFSI anions was confirmed by the negligible capacity of molten salt Na—Ar cells with Ni/NaTFSI/KTFSI/SS electrodes (FIG. 11D). Molten-salt Na—O₂ cells with Ni/NaTFSI/KTFSI/SS electrodes discharged at 483 K showed a much higher discharge voltage of ˜2.6 V (FIG. 11D) compared to Ni/NaNO₃/KNO₃/CsNO₃/SS electrodes. Significantly, Raman spectra of the discharged Ni/NaTFSI/KTFSI/SS electrode indicated the formation of Na₂CO₃ (1080 cm⁻¹, A′₁ (CO₃²⁻)) and K₂CO₃ (1055 cm⁻¹, A′₁ (CO₃²⁻)), but not Na₂O₂. See, FIGS. 17A and 17B. The formation of Na₂CO; and K₂CO₃ could be attributed to the decomposition of the TFSI anion, the only major source of carbon in the electrode. Acid-base titration measurements confirmed that negligible amounts of NaO₂, Na₂O₂ or Na₂O were present in discharged Ni/NaTFSI/KTFSI/SS electrodes. The formation of parasitic Na₂CO₃ and K₂CO₃ during the discharge of Ni/NaNO₃/KNO₃/CsNO₃/SS electrodes was consistent with negligible capacity (<0.03 mAh/cm²_{geo}) upon charging to 3 V. Through comparison of NaNO₃/KNO₃/CsNO₃ and NaTFSI/KTFSI electrolytes, it was clear that redox-active (e.g., nitrate) anions were critical for highly cyclable molten-salt Na—O₂ batteries.

Chemical Oxidation of Na₂O and NaNO₂ by O₂

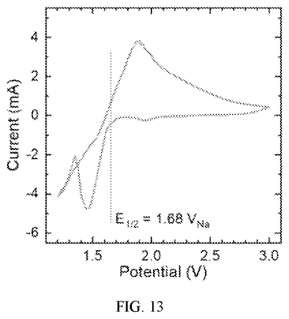

NaNO₂ can be oxidized chemically by O₂ to form NaNO₃, while Na₂O can react with O₂ to form Na₂O₂ in Ni/NaNO₃/KNO₃/CsNO₃/SS electrodes. In order to assess the reaction between Na₂O and O₂, Ni/NaNO₃/KNO₃/CsNO₃/SS electrodes were prepared with added Na₂O, and held at 443 K in both an O₂ and Ar environment for 48 hours. Following 48 hours in an Ar environment, the Raman spectra of the Ni/NaNO₃/KNO₃/CsNO₃/SS electrode with added Na₂O was largely unchanged, retaining a strong signal at 237 cm⁻¹ from Na₂O (FIG. 14A). On the other hand, following the reaction in an O₂ environment, the Raman peak for Na₂O at 237 cm⁻¹ disappeared and new Raman peaks at 733 (A′₁ (Na₂O₂)), 754 (Ag(Cs₂O₂)), 773 (Ag(K₂O₂)), and 789 cm⁻¹ (A′₂ (Na₂O₂)) appeared. (Refs. 44-45) The disappearance of Na₂O and appearance of Na₂O₂ can be attributed to the reaction given by Na₂O+½O₂→Na₂O₂, which is supported by the fact that Na₂O₂ is thermodynamically more stable than Na₂O and NaO₂ at 443 K, as shown in FIG. 14B. The two distinct Raman peaks at 1052 and 1068 cm⁻¹ associated with the overlapping A_{1g} modes of KNO₃⁵¹/CsNO₃⁵² and the A_{1g} mode of NaNO₃⁵³, respectively, in the pristine electrode became a single broad peak at 1054 cm⁻¹ following the reactions in Ar and O₂, where this change was attributed to the formation of a glassy NaNO₃/KNO₃/CsNO₃ state (Ref. 54) following fast cooling of the cell. The reactions of Na₂O and NaNO₂ with O₂ were further examined by exposing a Ni/NaNO₃/KNO₃/CsNO₃/SS electrode discharged to 7.6 mAh/cm²_{geo} in a He environment, to O₂ at 443 K for 7 hours. Pressure tracking measurements upon the introduction of O₂ showed an initial, very rapid decrease in pressure, following which the pressure slowly stabilized over ˜6 hours. See, FIG. 17. By fitting the O₂ consumption curve over the first 3 mins a rate of ˜0.18 mmol/h was determined, corresponding to a current density of 25 mA/cm²_{geo} and indicating that the reactions of Na₂O and/or NaNO₂ with O₂ can be very fast. This finding is in agreement with previous work (Ref. 55) that indicates that NO₂⁻ can be oxidized by O₂ to form NO; in bulk NaNO₃/KNO₃ molten salt at temperatures over 573 K.

### Nitrate-Mediated Oxygen Reduction Reaction in Na—O₂ Batteries

The oxygen reduction reaction in molten-salt Na—O₂ batteries occurs via a nitrate-mediated mechanism whereby NaNO₃ is first reduced electrochemically to form Na₂O and NaNO₂ (reaction 1), following which Na₂O reacts with O₂ to form Na₂O₂ (reaction 2), and NaNO₂ is oxidized by O₂ to regenerate NaNO₃ (reaction 3), resulting in an apparent 2 e⁻/O₂ overall reaction given by 2Na++O₂+2e⁻→Na₂O₂ (reaction 4). In the proposed reaction scheme nitrate anions are not consumed during discharge such that the entire discharge capacity comes from the overall 2e⁻/O₂ reduction of O₂ to Na₂O₂. Each step of the nitrate-mediated 2 e⁻/O₂ reaction has been demonstrated above, where the electrochemical reduction of NaNO₃ to Na₂O and NaNO₂ was observed in Na—Ar cells (FIGS. 11A-11D), and the oxidation of Na₂O and NaNO₂ by O₂ was shown through chemical experiments (FIGS. 14A-14B). Further evidence that the formation of Na₂O₂ from O₂ was facilitated by nitrate anions comes from ¹⁸O-isotopic labelling, where according to the purposed mechanism, discharge of Ni/NaN¹⁶O₃/KN¹⁶O₃/CsN¹⁶O₃/SS electrodes in a ³⁶O₂ (¹⁸O¹⁸O) environment would proceed via:

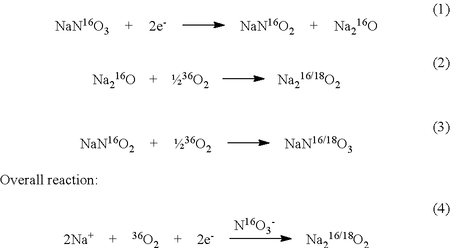

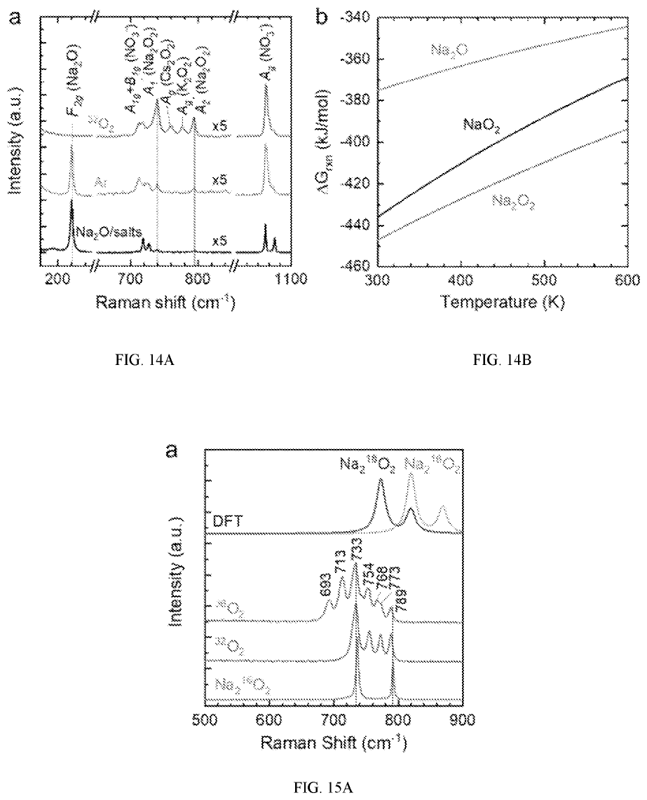

Raman spectroscopy of a Ni/NaN¹⁶O₃/KN¹⁶O₃/CsN¹⁶O₃/SS electrode discharged in a ³⁶O₂ (¹⁸O¹⁸O) environment showed evidence of red-shifted Raman peaks associated with ¹⁸O-enrichment of both NaNO₃ (reaction 2) and Na₂O₂ (reaction 3). As shown in FIG. 15A, ³⁶O₂ discharged electrodes showed several new red-shift peaks at 693, 713, and 768 cm⁻¹ in the O—O stretching region relative to those of ¹⁶O-substituted peroxides at 733, 754, 773, and 789 cm⁻¹, which could be attributed to ¹⁸O-substituted peroxides. Such red shifts of ¹⁸O-substituted Na₂O₂ are supported by the density functional theory (DFT) computed Raman spectra for Na₂¹⁸O₂ and Na₂¹⁶O₂, where the bands of Na₂¹⁸O₂ were shifted by 46 cm⁻¹ relative to Na₂¹⁶O₂ (FIG. 15A). While red-shifted Raman bands appeared in the ³⁶O₂ discharged electrodes, the band at 789 cm⁻¹ attributable to Na₂¹⁶O₂ remained, suggesting the discharge product was a mixture of Na₂₁₈₀₂ and Na₂¹⁶O₂. In addition, in the NO₃ symmetric stretching region, there were also red-shift peaks at 1010, 1013, 1018, 1029, 1033, 1037, 1045, and 1057 cm⁻¹, consistent with the formation of ¹⁸O-substituted NaNO₃, KNO₃ and CsNO₃ (FIG. 15B). Such red shifts in the NO₃ symmetric stretching region due to ¹⁸O-enrichment was supported by simulated wavenumber of symmetric stretching as a function of ¹⁸O-substituted-N¹⁶O₃⁻ (FIG. 15B) obtained from DFT calculations of the isolated anion in vacuum at the B3LYP/6-31G (d,p) level, where greater red-shifts in the symmetric stretching were correlated with more ¹⁸O substitution in N¹⁶O₃⁻. The presence of ¹⁸O-substituted-N¹⁶O₃⁻ can be attributed to the oxidation of N¹⁶O₂₋ by ³⁶O₂ given by reaction (3).

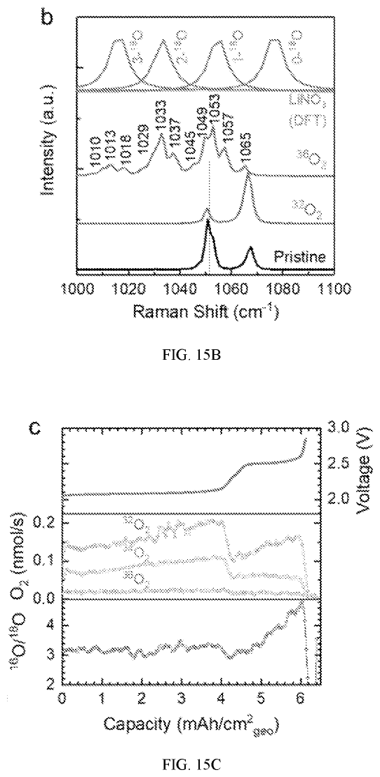

Further evidence of a nitrate-mediated, apparent 2 e⁻/O₂ oxygen reduction reaction came from differential electrochemical mass spectroscopy (DEMS) ¹⁸O-isotopic labelling experiments that showed that evolved oxygen came primarily from nitrate anions, as opposed to the O₂ discharge environment. DEMS measurements were conducted using a symmetric molten-salt Na—O₂ cell discharged in ³⁶O₂ (FIG. 15C). The negative electrode used in the DEMS cell was prepared in a Na—Ar cell with discharge capacity of 1.6 mAh/cm²_{geo} to achieve a flat discharge plateau. Upon charging at 0.2 mA/cm²_{geo}, three types of molecular oxygen (i.e., ³²O₂ (¹⁶O¹⁶O), ³⁴O₂ (¹⁶O¹⁸O), and ³⁶O₂ (¹⁸O¹⁸O)) were detected, consistent with the decomposition of Na₂¹⁶O¹⁶O, Na₂¹⁶O¹⁸O and Na₂¹⁸O¹⁸O, respectively. Remarkably, the amount of ³⁶O₂ evolved was very small (<2%), which indicated only a small amount of Na₂¹⁸O¹⁸O was formed during discharge in ³⁶O₂, consistent with a nitrate-mediated reaction, as opposed to the direct reduction of O₂ to Na₂O₂. The high proportion (90%) of ³²O₂ (¹⁶O¹⁶O) detected during charge is in disagreement with reactions (1) to (4), which can be attributed to either 1) that the electrochemical reduction of NaNO₃ to Na₂O₂ given by NaNO₃+Na⁺+e⁻→NaNO₂+½Na₂O₂ can contribute more significantly to the discharge process in Na—O₂ cells as opposed to that observed in Na—Ar cells in FIG. 11A, 2) that the lower O₂ pressure for ³⁶O₂ cells ˜100 kPa as opposed to ³²O₂ cells ˜410 kPa slowed reactions (2) and (3), resulting in a higher proportion of Na₂¹⁶O in the discharged electrode, which could evolve ³²O₂ (¹⁶O¹⁶O) or 3) that the nitrate-mediated reaction pathway is more complex than that given by reactions (1)-(4). Although this discrepancy motivates additional research into the detailed mechanism, the high ratio of ¹⁶O/¹⁸O ˜3 in FIG. 15C strongly supports the hypothesis of a nitrate-mediated oxygen reduction reaction instead of direct O₂ reduction in molten-salt Na—O₂ cells. The Raman spectra of Ni/salts electrodes before and after reaction are shown in FIG. 16.

Described herein is a molten-salt Na—O₂ battery where the formation of Na₂O₂ is mediated by the electrochemical activity of nitrate anions. In molten-salt Li—O₂ batteries (Ref. 19), the redox activity of nitrate anions can result in the formation of Li₂O upon discharge at 423 K; however, the Li₂O formed from the reduction of NO₃ to NO₂ is thermodynamically preferred to Li₂O₂¹⁸, whereas in Na—O₂ cells, Na₂O can further react with O₂ to form Na₂O₂. The mediation of the oxygen reduction reaction by nitrate anions in molten-salt Li—O₂ and Na—O₂ cells has a number of interesting implications on the cell design and performance. First, the catalytic activity of the electrode surface towards nitrate redox is critical to enable high rates and low overpotentials. In molten-salt Li—O₂ cells, NiO was identified as having high catalytic activity due to its optimum binding of NO₃⁻ and NO₂⁻, where weaker binding catalysts like Cu₂O were limited by NO₃⁻ adsorption whereas stronger binding catalysts like Mn₃O₄ were limited by the oxidation of NO₂⁻ by O₂. (Ref. 19) The high performance of Ni-based catalysts for nitrate redox is in agreement with previous reports for Li—Ar cells. (Refs. 19, 49) Second, the high weight of Ni-based electrodes limits the achievable specific energy of the positive electrode (Refs. 18, 19), necessitating the development of novel electrode materials with high catalytic activity for nitrate redox with lower weight, such as Ni-coated carbon. (Ref. 18) Third, while the electrolyte was not consumed in the overall reaction where nitrate anions can participate in multiple catalytic cycles over the span of a single discharge (reactions 1-3), the role of nitrate's redox activity in the oxygen reduction reaction may introduce limitations in the lean-electrolyte regime needed to achieve high cell level specific energy. Fourth, the blocking of O₂ within the electrode due to accumulation of the discharge product may shift the discharge product towards the formation of Na₂O at deeper discharges, which may be responsible for the presence of minor Na₂O in addition to major Na₂O₂ in deep discharge observed in FIG. 9F. Finally, the temporary formation of NO₂⁻ in the electrolyte during discharge may locally alter the physicochemical properties of the molten salt electrolyte, such as its melting point, viscosity or ionic conductivity. During charging, recent work (Ref. 56) has shown that the 2 electron oxidation of bulk Na₂O₂ to O₂ is limited by the last step (NaO₂→O₂+Na⁺+e⁻), which is known to occur with small overpotentials in Na—O₂ cells with aprotic solvents (Ref. 39), rationalizing the small charging overpotentials observed in this work. Molten-salt Na—O₂ batteries can achieve promising areal energy (33 mWh/cm²_{geo}) and power densities (19 mW/cm²_{geo}) as well as stable cycling (400 cycles) and desirable energy efficiencies ˜90%.

In summary, high-performance molten-salt Na—O₂ batteries with a simple structure are reported, utilizing a nitrate-mediated reaction to achieve >2e⁻/O₂. First, the electrochemical performance of these molten-salt Na—O₂ batteries was investigated, showing high power density (19 mW/cm²_{geo}) at 10 mA/cm²_{geo} and high-energy efficiency (˜90%) at a high current density of 5 mA/cm²_{geo}, with long cycle life (400 cycles). Next, using Raman, pressure tracking and titration measurements, the dominant discharge product was shown to be Na₂O₂. The redox activity of nitrate anions was studied in Na—Ar cells, showing that NaNO; could be electrochemically reduced to Na₂O and NaNO₂, where Na₂O and NaNO₂ could further react chemically with O₂. Finally, using ¹⁸O-labeling experiments, the oxygen reduction reaction in molten-salt Na—O₂ batteries was shown to have occurred via a nitrate-mediated mechanism whereby NaNO₃ was first electrochemically reduced to form Na₂O and NaNO₂, following which Na₂O reacted with O₂ to form Na₂O₂, while NaNO₂ was oxidized by O₂ to regenerate NaNO₃, resulting in an apparent 2 e⁻/O₂ overall reaction to form Na₂O₂. Such nitrate-mediated molten-salt Na—O₂ batteries provide an innovative approach to develop alkali metal-O₂ batteries with high energy and power density.

Each of the following references, some of which are cited above with the notation “Ref.”, is incorporated by reference in its entirety.

### REFERENCES

1. S. J. Davis, N. S. Lewis, M. Shaner, S. Aggarwal, D. Arent, I. L. Azevedo, S. M. Benson, T. Bradley, J. Brouwer and Y.-M. Chiang, Science, 2018, 360, eaas9793.
2. H. Liu, X.-B. Cheng, Z. Jin, R. Zhang, G. Wang, L.-Q. Chen, Q.-B. Liu, J.-Q. Huang and Q. Zhang, EnergyChem, 2019, 1, 100003.
3. H. Wang, D. Yu, C. Kuang, L. Cheng, W. Li, X. Feng, Z. Zhang, X. Zhang and Y. Zhang, Chem, 2019, 5, 313-338.
4. J. Xie, L. Liao, Y. Gong, Y. Li, F. Shi, A. Pei, J. Sun, R. Zhang, B. Kong and R. Subbaraman, Science advances, 2017, 3, eaao3170.
5. D. Lin, Y. Liu and Y. Cui, Nature nanotechnology, 2017, 12, 194.
6. Y.-C. Lu, B. M. Gallant, D. G. Kwabi, J. R. Harding, R. R. Mitchell, M. S. Whittingham and Y. Shao-Horn, Energy Environ. Sci., 2013, 6, 750-768.
7. J. Read, K. Mutolo, M. Ervin, W. Behl, J. Wolfenstine, A. Driedger and D. Foster, J. Electrochem. Soc., 2003, 150, A1351-A1356.
8. W. T. Hong, M. Risch, K. A. Stoerzinger, A. Grimaud, J. Suntivich and Y. Shao-Horn, Energy Environ. Sci., 2015, 8, 1404-1427.
9. D. Aurbach, B. D. McCloskey, L. F. Nazar and P. G. Bruce, Nat. Energy, 2016, 1, 16128.
10. Y.-C. Lu, H. A. Gasteiger and Y. Shao-Horn, J. Am. Chem. Soc., 2011, 133, 19048-19051.
11. US20120028,137, 2012.
12. Y. Chen, S. A. Freunberger, Z. Peng, O. Fontaine and P. G. Bruce, Nat. Chem., 2013, 5, 489-494.
13. M. M. Ottakam Thotiyl, S. A. Freunberger, Z. Peng and P. G. Bruce, J. Am. Chem. Soc., 2012, 135, 494-500.
14. Y. G. Zhu, F. T. Goh, R. Yan, S. Wu, S. Adams and Q. Wang, Physical Chemistry Chemical Physics, 2018, 20, 27930-27936.
15. B. McCloskey, D. Bethune, R. Shelby, G. Girishkumar and A. Luntz, The Journal of Physical Chemistry Letters, 2011, 2, 1161-1166.
16. S. Feng, M. Huang, J. R. Lamb, W. Zhang, R. Tatara, Y. Zhang, Y. G. Zhu, C. F. Perkinson, J. A. Johnson and Y. Shao-Horn, Chem, 2019, 5, 2630-2641.
17. V. Giordani, D. Tozier, H. Tan, C. M. Burke, B. M. Gallant, J. Uddin, J. R. Greer, B. D. McCloskey, G. V. Chase and D. Addison, J. Am. Chem. Soc., 2016, 138, 2656-2563.
18. C. Xia, C. Y. Kwok and L. F. Nazar, Science, 2018, 361, 777-781.
19. D. Koo and S. J. Kang, ACS Applied Materials & Interfaces, 2021, 13, 47740-47748.
20. Y. G. Zhu, G. Leverick, L. Giordano, S. Feng, Y. Zhang, Y. Yu, R. Tatara, J. R. Lunger and Y. Shao-Horn, Joule, 2022, DOI: https://doi.org/10.1016/j.joule.2022.06.032.
21. K. Baek, J. G. Lee, A. Cha, J. Lee, K. An and S. J. Kang, Journal of Power Sources, 2018, 402, 68-74.
22. C. Peng, C. Guan, J. Lin, S. Zhang, H. Bao, Y. Wang, G. Xiao, G. Z. Chen and J. Q. Wang, ChemSusChem, 2018, 11, 1880-1886.
23. S. Zhang, Y. Yang, L. Cheng, J. Sun, X. Wang, P. Nan, C. Xie, H. Yu, Y. Xia and B. Ge, Energy Storage Materials, 2021, 35, 142-147.
24. S. Liu, W. Han, B. Cui, X. Liu, F. Zhao, J. Stuart and S. Licht, Journal of Power Sources, 2017, 342, 435-441.
25. M. Shahabi, N. Masse, H. Sun, L. Wallace, A. Powell and Y. Zhong, in REWAS 2022: Energy Technologies and CO₂ Management (Volume II), Springer, 2022, pp. 47-57.
26. S. Xia, X. Wu, Z. Zhang, Y. Cui and W. Liu, Chem, 2019, 5, 753-785.
27. X. Guo, L. Zhang, Y. Ding, J. B. Goodenough and G. Yu, Energy Environ. Sci., 2019, 12, 2605-2619.
28. B. D. McCloskey, A. Valery, A. C. Luntz, S. R. Gowda, G. M. Wallraff, J. M. Garcia, T. Mori and L. E. Krupp, The journal of physical chemistry letters, 2013, 4, 2989-2993.
29. L. S. Darken and H. F. Meier, J. Am. Chem. Soc., 1942, 64, 621-623.
30. J. Berkowitz, D. J. Meschi and W. A. Chupka, J. Chem. Phys., 1960, 33, 533-540.
31 P. D. Hooker and K. J. Klabunde, Chemistry of materials, 1993, 5, 1089-1093.
32. J. R. Harding, Massachusetts Institute of Technology, 2015.
33. K. H. Stern, Journal of Physical and Chemical Reference Data, 1972, 1, 747-772.
34. N. Ortiz-Vitoriano, T. P. Batcho, D. G. Kwabi, B. Han, N. Pour, K. P. C. Yao, C. V. Thompson and Y. Shao-Horn, The Journal of Physical Chemistry Letters, 2015, 6, 2636-2643.
35. X. Gao, Y. Chen, L. Johnson and P. G. Bruce, Nat. Mater., 2016, 15, 882-888.
36. Z. Peng, S. A. Freunberger, Y. Chen and P. G. Bruce, Science, 2012, 337, 563-566.
37. Z. Zhu, A. Kushima, Z. Yin, L. Qi, K. Amine, J. Lu and J. Li, Nat. Energy, 2016, 1, 16111.
38. Y. Qiao, K. Jiang, H. Deng and H. Zhou, Nat. Catal., 2019, 2, 1035-1044.
39. P. Hartmann, C. L. Bender, M. Vračar, A. K. Dürr, A. Garsuch, J. Janek and P. Adelhelm, Nat. Mater., 2013, 12, 228-232.
40. H. Yadegari, M. N. Banis, B. Xiao, Q. Sun, X. Li, A. Lushington, B. Wang, R. Li, T.-K. Sham, X. Cui and X. Sun, Chem Mater, 2015, 27, 3040-3047.
41. G. Cong, W. Wang, N.-C. Lai, Z. Liang and Y.-C. Lu, Nat. Mater., 2019, 18, 390-396.
42. W. Wang, N.-C. Lai, Z. Liang, Y. Wang and Y.-C. Lu, Angew. Chem. Int. Ed., 2018, 57, 5042-5046.
43. X. Ren and Y. Wu, J. Am. Chem. Soc., 2013, 135, 2923-2926.
44. H. Eysel and S. Thym, Z Anorg Allg Chem, 1975, 411, 97-102.
45. T. Livneh, A. Band and R. Tenne, J Raman Spectrosc, 2002, 33, 675-676.
46. R. Benages-Vilau, T. Calvet, M. A. Cuevas-Diarte and H. A. J. Oonk, Phase Transit, 2016, 89, 1-20.
47. K. Persson, Journal, 2014, DOI: 10.17188/1263112.
48. M. Jansen, Angew. Chem. Int. Ed. Engl., 1976, 15, 376-377.
49. V. Giordani, D. Tozier, J. Uddin, H. Tan, B. M. Gallant, B. D. McCloskey, J. R. Greer, G. V. Chase and D. Addison, Nat. Chem., 2019, 11, 1133-1138.
50. US Pat., 2009.
51. R. Carr, J. Vanos and B. H. Torrie, Chem Phys Lett, 1979, 65, 73-76.
52. M. Brooker, J. Chem. Phys., 1973, 59, 5828-5829.
53. D. Rousseau, R. Miller and G. Leroi, J. Chem. Phys., 1968, 48, 3409-3413.
54. M. K. Raju, presented in part at the Proceedings of the Indian Academy of Sciences-Section A, 1945.
55. V. A. Sotz, A. Bonk, J. Forstner and T. Bauer, Thermochim Acta, 2019, 678, 178301.
56. J. R. Lunger, N. Lutz, J. Peng, M. Bajdich and Y. Shao-Horn, Chem Mater, 2022, 34, 3872-3881.
57. X. Gao, Y. Chen, L. Johnson and P. G. Bruce, Nat. Mater., 2016, 15, 882-888.
58. C. Xia, C. Y. Kwok and L. F. Nazar, Science, 2018, 361, 777-781.
59. V. Giordani, D. Tozier, H. Tan, C. M. Burke, B. M. Gallant, J. Uddin, J. R. Greer, B. D. McCloskey, G. V. Chase and D. Addison, J. Am. Chem. Soc., 2016, 138, 2656-2563.
60. Z. Peng, S. A. Freunberger, Y. Chen and P. G. Bruce, Science, 2012, 337, 563-566.
61. Z. Zhu, A. Kushima, Z. Yin, L. Qi, K. Amine, J. Lu and J. Li, Nat. Energy, 2016, 1, 16111.
62. Y. Qiao, K. Jiang, H. Deng and H. Zhou, Nat. Catal., 2019, 2, 1035-1044.
63. P. Hartmann, C. L. Bender, M. Vračar, A. K. Dürr, A. Garsuch, J. Janek and P. Adelhelm, Nat. Mater., 2013, 12, 228-232.
64. H. Yadegari, M. N. Banis, B. Xiao, Q. Sun, X. Li, A. Lushington, B. Wang, R. Li, T.-K. Sham, X. Cui and X. Sun, Chem Mater, 2015, 27, 3040-3047.
65. G. Cong, W. Wang, N.-C. Lai, Z. Liang and Y.-C. Lu, Nat. Mater., 2019, 18, 390-396.
66. W. Wang, N.-C. Lai, Z. Liang, Y. Wang and Y.-C. Lu, Angew. Chem. Int. Ed., 2018, 57, 5042-5046.
67. X. Ren and Y. Wu, J. Am. Chem. Soc., 2013, 135, 2923-2926.
68. S. M. Davison and A. C. Sun, Ind Eng Chem Res, 2011, 50, 12617-12625.
69. D. R. Lide, CRC handbook of chemistry and physics, CRC press, 2004.
70. I. Barin, Thermochemical data of pure substances, 1989.
71. R. C. Weast, M. J. Astle and W. H. Beyer, CRC handbook of chemistry and physics, CRC press Boca Raton, FL, 1988.
72. J. Balej, Collect. Czech. Chem. Commun., 2011, 76, 407-414.
73. T. Livneh, A. Band and R. Tenne, J Raman Spectrosc, 2002, 33, 675-676.
74. R. A. Robie and B. S. Hemingway, Thermodynamic properties of minerals and related substances at 298.15 K and 1 bar (105 Pascals) pressure and at higher temperatures, US Government Printing Office, 1995.

Other embodiments are within the scope of the following claims.

The invention claimed is:

1. A molten-salt Na—O₂ battery comprising:
a first electrode comprising liquid Na in direct contact with a solid-state electrolyte; and
a composite second electrode in contact with the solid-state electrolyte, wherein the composite second electrode comprises:
particles having an oxygen-active metal surface; and
a molten salt comprising redox-active ions; and
oxygen in contact with the composite second electrode;
wherein the solid-state electrolyte is disposed between the first electrode and the composite second electrode.

2. The battery of claim 1, wherein the redox-active ions are nitrate (NO₃⁻) ions.

3. The battery of claim 1, wherein the molten salt comprises a eutectic alkali metal-nitrate mixture.

4. (canceled)

5. The battery of claim 1, wherein the particles having an oxygen-active metal surface comprise Ni, Cu, or a combination thereof.

6. The battery of claim 1, wherein the particles having an oxygen-active metal surface include at least some metal oxide.

7. (canceled)

8. The battery of claim 1, wherein the solid-state electrolyte is a β-Al₂O₃ membrane.

9. The battery of claim 1, wherein the battery is characterized by an areal energy density of at least about 30 mWh/cm²_{geo}.

10. The battery of claim 1, wherein the battery is characterized by an areal power density of at least about 15 mW/cm²_{geo}.

11. The battery of claim 1, wherein the battery is characterized by stable cycling through at least about 400 charge-discharge cycles.

12. The battery of claim 1, wherein the battery is characterized by an energy efficiency of at least about 85%.

13. A battery comprising molten salt Na—O₂, a dendrite-free liquid-Na electrode, stable nickel positive electrode, and fast kinetics of oxygen reduction and oxidation.

14. The battery of claim 13, further comprising a NaNO₃/KNO₃/CsNO₃ eutectic electrolyte and a β-Al₂O₃ membrane.

15. (canceled)

16. The battery of claim 13, wherein the battery has an energy efficiency of greater than 90%.

17. The battery of claim 13, wherein the battery has a current of 10 mA/cm²_{geo}.

18. (canceled)

19. A method of making a molten-salt Na—O₂ battery comprising:
providing a battery housing;
loading the battery housing with an amount of Na;
assembling a solid-state electrolyte within the battery housing such that the solid-state electrolyte directly contacts the Na;
forming a composite second electrode, wherein forming comprises combining metal particles and a redox-active salt in predetermined ratios, thereby yielding a solid mixture, and compressing the solid mixture on a conductive substrate; and
assembling the composite second electrode within the battery housing such that the solid-state electrolyte is disposed between the Na and the composite second electrode.

20. The method of claim 19, further comprising loading the battery housing with an amount of O₂, wherein the O₂ is in contact with composite second electrode and separated from the Na.

21. The method of claim 19, further comprising exposing the assembled battery to a predetermined operating temperature, wherein at predetermined operating temperature, the Na is liquid and the redox-active salt is a molten salt.

22. (canceled)

23. The method of claim 19, wherein the metal particles are Ni nanoparticles.

24. A method of producing electricity, comprising:
providing a molten-salt Na—O₂ battery comprising:
a first electrode comprising liquid Na in direct contact with a solid-state
electrolyte;
a composite second electrode in contact with the solid-state electrolyte, wherein the composite second electrode comprises:
particles having an oxygen-active metal surface; and a molten salt comprising redox-active ions;
wherein the solid-state electrolyte is disposed between the first electrode and the composite second electrode;
allowing O₂ to contact the composite second electrode;
exposing the battery to a predetermined operating temperature selected to maintain Na in a liquid state and to maintain the molten salt in a molten state; and
providing an electrical connection between the first electrode and the second composite electrode.

25. (canceled)

26. The method of claim 24, wherein the particles having an oxygen-active metal surface are Ni nanoparticles.
